(19) United States
(12) Patent Application Publication
(10) Pub. No.: US 2011/0032489 A1
(43) Pub. Date: Feb. 10, 2011

(54) IMAGE DISPLAY DEVICE

(76) Inventors: Takayuki Kimoto, Osaka (JP); Hirosi Kitano, Hyogo (JP); Kazuya Chiba, Osaka (JP); Takaaki Tanaka, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/988,333

(22) PCT Filed: Jun. 12, 2009
(86) PCT No.: PCT/JP2009/002665

§ 371 Date: Oct. 18, 2010

(30) Foreign Application Priority Data
Jun. 13, 2008 (JP) 2008155026
Sep. 30, 2008 (JP) 2008253112
Nov. 14, 2008 (JP) 2008292253

(51) Int. Cl. G03B 21/16

(52) U.S. Cl. 353/56

(57) ABSTRACT

Comprising a casing containing a heat insulating part, a projector as an image display unit, a screen for displaying an image issued from the projector, and cooling part (heat exchanger, compressor) for cooling the inside of the casing, the heat insulating part includes a first heat insulating part disposed in the peripheral area of the projector for insulating from heat, and a second heat insulating part disposed in the peripheral part of the screen for insulating from heat.

### TECHNICAL FIELD

The present invention relates to an image display device, and more particularly to an image display device used outdoors and in other environments exposed to external light or illumination.

### BACKGROUND ART

In recent years, in the background of the image display device becoming larger in size, higher in luminance, higher in definition, and wider in network environment, conventional roadside posters are being progressively replaced by video media, and the distribution business of electronic advertising is rapidly spreading. In roadside posters, every time the advertising contents are changed, posters must be pasted again, but in the case of electronic advertising, the advertising contents are updated instantly only by changing the contents of the distribution server, and it is highly regarded as useful advertising media.

In electronic advertising, a large screen of video display device is installed in a public outdoor place for unspecified multiple viewers. Different from an indoor video display, an outdoor advertising display requires a display image quality of high definition and high luminance, and keeping of display quality on a large screen is very important. Especially, in outdoor display, sufficient considerations about effects of dust, wind and rain should be required.

Display of a large screen is realized by direct wide-screen display by using liquid crystal display, plasma display, LED, or other display device, or by magnified projection of image information by using projector or the like.

Among them, the display device using an LED can present an image of high luminance, but since the pixel pitch is rough, the screen size must be increased if desired to be higher in definition, and it leads to a high cost. Along with increase of screen size, the power consumption also increases.

In the case of liquid crystal display or plasma display, an image of high definition can be presented, but the luminance is insufficient in an ordinary indoor display, and the power consumption is increased extremely when desired to obtain a high luminance. Still more, in these direct-viewing displays; when the panel area is exposed to a direct sunlight, the temperature of display constituent elements disposed closely to the inside of the panel is elevated, and the performance deteriorates.

On the other hand, in the case of projector display, two methods are available, that is, the rear projection type (rear method) projector for projecting the image to a transmission type screen by way of a mirror, and the front projection type (front method) projector for projecting the image through a projector or directly to a reflection type screen, and since the projection unit is installed away from the screen, effects of direct sunlight may be decreased as compared with the direct-viewing type display.

However, the light source of the projector may become a heating element, and in addition, by the use of DMD (digital micro-mirror device), liquid crystal device or other image display device, polarization filter, and other optical devices likely to deteriorate in performance due to elevation of temperature, it is important to cooling the inside of the casing efficiently. In particular, in an outdoor environment exposed to direct sunlight, the temperature elevation of the casing due to direct sunlight is a serious problem, and it is important to manage the temperature of the projector in consideration of the environment of use.

So far, as the display device for outdoor installation, for example, methods of disposing an air conditioner inside of the casing of a projector are being proposed (see, for example, patent documents 1 to 3).

Moreover, as the technology for cooling the projection type display device efficiently, methods of enhancing the cooling effect by using the air conditioner, heat exchanger, heat insulating material, partition board and the like are being conventionally disclosed (see, for example, patent documents 4 to 6).

However, the disclosed technology for enhancing the cooling effect of the projector is not sufficient in the measure for outdoor installation. In patent documents 1 to 3, nothing specific is described about appropriate utilization of the performance of the air conditioner. In patent documents 4 to 6 relate to the cooling structure of the image display element and its peripheral parts, but nothing specific is mentioned about optimization of cooling of the entire casing including the screen.

In particular, when used outdoors as advertising media in place of roadside posters, a particular consideration is indispensable about the environment of installation of the entire casing including the screen, and a severe weather resistance about conditions of ambient temperature and sunlight are required.

The conventional technology for enhancing the cooling effect in the projection type image display device using a projector is limited only in the cooling effect of the projection unit mainly composed of image display elements, and is not sufficient for comprehensively satisfying the cooling conditions of the entire constituent elements installed in the device including the light source and the screen, and the cooling effect is insufficient as the image display device to be installed in various outdoor environments.

Also in the outdoor environments, it is important to assure a sufficient visual recognition of the projected image, but the conventional form of projection applied in an indoor projector is not sufficient in the luminance.

For the purpose of outdoor installation, the conventional configuration not having dust-proof structure tends to deteriorate in the display quality, which may lead to troubles, and the outdoor installation was difficult.

Still more, outdoors, the temperature changes are significant, and dew condensation is likely to occur due to temperature difference of indoors and outdoors of the image display device. If the power source is turned on in dew condensation state, troubles are caused, and the power source circuit may be broken, and safety problems are inevitable.

When an air conditioner is used as cooling means, the display image projected on the screen may flicker and fluctuate due to vibrations.

In the case of outdoor installation, risk of theft is possible, and antitheft measures should be required.

### Prior Art Literature

### Patent Documents

Patent document 1: Unexamined Japanese Patent Publication No. 2002-311508

Patent document 2: Unexamined Japanese Patent Publication No. 2002-341810

Patent document 3: Unexamined Japanese Patent Publication No. 2003-149739

Patent document 4: Unexamined Japanese Patent Publication No. 2000-298311

Patent document 5: Unexamined Japanese Patent Publication No. 2005-148624

Patent document 6: Unexamined Japanese Patent Publication No. 2001-209125

### SUMMARY OF THE INVENTION

The image display device of the present invention is an image display device including an image display unit capable of projecting forward an image in a specified dimension and at a specified luminance at a specified projection distance, and a transmission type screen for displaying the image projected by the image display unit, both contained in a casing, for projecting backward the image to the screen disposed on a projection route of the image display unit, in which the casing includes a heat insulating part, and a cooling part for cooling the inside of the casing, and the heat insulating part has a first heat insulating part disposed in a peripheral part of the image display unit for insulating from heat, and a second heat insulating part disposed in a peripheral part of the screen for insulating from heat.

In such configuration, by the first heat insulating part disposed in a peripheral part of the image display unit for insulating from heat, and the second heat insulating part disposed in a peripheral part of the screen for insulating from heat, the inside of the image display device is divided to be insulated from heat, so that the image display unit and the screen can be cooled. Therefore, in the projection type image display device using the projector, the temperature can be controlled appropriately in various cooling conditions about mounted components and parts such as the projector and the screen, and an image display device of high definition and high luminance to be installed in various outdoor environments may be realized. In particular, excellent in weather resistance, the device can operate in severe ambient temperature conditions, and a very useful and convenient image display device suited to information presentation service such as outdoor advertising can be realized.

The image display device of the present invention is an image display device including an image display unit capable of projecting forward an image in a specified dimension and at a specified luminance at a specified projection distance, and a transmission type screen for displaying the image projected by the image display unit, both contained in a casing, for projecting backward the image to the screen disposed on a projection route of the image display unit, in which the casing includes a first accommodation part containing the image display unit, a second accommodation part containing the screen, and a third accommodation part containing a cooling part for cooling the inside of the casing, and the first accommodation part, the second accommodation part, and the third accommodation part are divided by wall surface members.

In such configuration, the casing has the first accommodation part containing the image display unit, the second accommodation part containing the screen, and the third accommodation part containing the cooling part for cooling the inside of the casing, and the first, second, and third accommodation parts are divided by wall surface members. Therefore, by separating the accommodating places of the image display unit and the cooling part securely, an efficient cooling route can be composed, and the cooling efficiency is enhanced, and structural adverse effects by disposition of the cooling part, other devices and parts such as vibration and dust can be suppressed. As a result, relating to the image display device for outdoor installation, in particular, the cooling function is enhanced, and the load of the cooling part is lessened, and the efficiency is improved, and it is hence possible to realize an image display device that can be installed in various outdoor environments, and is high in definition and luminance, and has a temperature adjusting function of high quality.

### BRIEF DESCRIPTION OF DRAWINGS

FIG. 1A is an explanatory diagram showing a basic concept of an image display device in accordance with a first exemplary embodiment of the present invention.

FIG. 1B is an explanatory diagram showing a basic concept of the image display device in accordance with the first exemplary embodiment, of the present invention.

FIG. 2 is a perspective view of outline of the image display device in accordance with the first exemplary embodiment of the present invention.

FIG. 3 is a layout diagram showing a principal configuration of the image display device in accordance with the first exemplary embodiment of the present invention.

FIG. 4A is a principal layout diagram showing an application example about the configuration of the image display device in preferred embodiment 1 of the present invention.

FIG. 4B is a principal layout diagram showing an application example about the configuration of the image display device in accordance with the first exemplary embodiment of the present invention.

FIG. 5 is a principal layout diagram showing an application example about the use of the image display device in accordance with the first exemplary embodiment of the present invention.

FIG. 6A is a sectional view showing a configuration of a screen of the image display device in accordance with the first exemplary embodiment of the present invention.

FIG. 6B is a perspective view showing a configuration of the screen of the image display device in accordance with the first exemplary embodiment of the present invention.

FIG. 7 is an optical characteristic diagram about a protective plate of the screen of the image display device in accordance with the first exemplary embodiment of the present invention.

FIG. 8 is a perspective view showing an example of a dustproof structure of the image display device in accordance with the first exemplary embodiment of the present invention.

FIG. 9 is a perspective view showing an example of the dustproof structure of the image display device in accordance with the first exemplary embodiment of the present invention.

FIG. 10 is a perspective view showing an example of the dustproof structure of the image display device in accordance with the first exemplary embodiment of the present invention.

FIG. 11 is a principal layout diagram showing an example of dew condensation countermeasure of the image display device in accordance with the first exemplary embodiment of the present invention.

FIG. 12 is a block diagram showing an example of a control circuit of dew condensation countermeasure of the image display device in accordance with the first exemplary embodiment of the present invention.

FIG. 13A is a principal layout diagram showing an example of vibration countermeasure of the image display device in accordance with the first exemplary embodiment of the present invention.

FIG. 13B is a partially magnified view showing an example of vibration countermeasure of the image display device in accordance with the first exemplary embodiment of the present invention.

FIG. 14 is a perspective view showing an example of vibration countermeasure of the image display device in accordance with the first exemplary embodiment of the present invention.

FIG. 15A is a diagram showing an example of relation between temperature and cooling sequence of the image display device in accordance with the first exemplary embodiment of the present invention.

FIG. 15B is a diagram showing an example of relation between temperature and heating sequence of the image display device in accordance with the first exemplary embodiment of the present invention.

FIG. 16A is a diagram showing an example of relation to the temperature when the number of lamps of a light source is controlled in the image display device in accordance with the first exemplary embodiment of the present invention.

FIG. 16B is a diagram showing an example of relation to the temperature when the lamp power of the light source is controlled in the image display device in accordance with the first exemplary embodiment of the present invention.

FIG. 17A is a principal layout diagram showing an example of circulation flow path of heat flow of the image display device in accordance with the first exemplary embodiment of the present invention.

FIG. 17B is a principal layout diagram showing an example of circulation flow path of heat flow of the image display device in accordance with the first exemplary embodiment of the present invention.

FIG. 18A is a principal layout diagram showing an example about safety measure of the image display device in accordance with the first exemplary embodiment of the present invention.

FIG. 18B is a principal layout diagram showing an example about safety measure of the image display device in accordance with the first exemplary embodiment of the present invention.

FIG. 19 is a layout diagram showing a basic concept of an image display device in accordance with a second exemplary embodiment of the present invention.

FIG. 20 is a principal layout diagram showing an application example about configuration of the image display device in accordance with the second exemplary embodiment of the present invention.

FIG. 21A is a front view showing a principal layout of a specific configuration example of the image display device in accordance with the second exemplary embodiment of the present invention.

FIG. 21B is a side view showing a principal layout of a specific configuration example of the image display device in accordance with the second exemplary embodiment of the present invention.

FIG. 22A is a diagram showing a setting example of control mode relating to temperature control of the inside when the air conditioner is in OFF mode of the image display device in accordance with the second exemplary embodiment of the present invention.

FIG. 22B is a diagram showing a setting example of control mode relating to temperature control of the inside when the air conditioner is in ON mode of the image display device in accordance with the second exemplary embodiment of the present invention.

### PREFERRED EMBODIMENTS FOR CARRYING OUT THE INVENTION

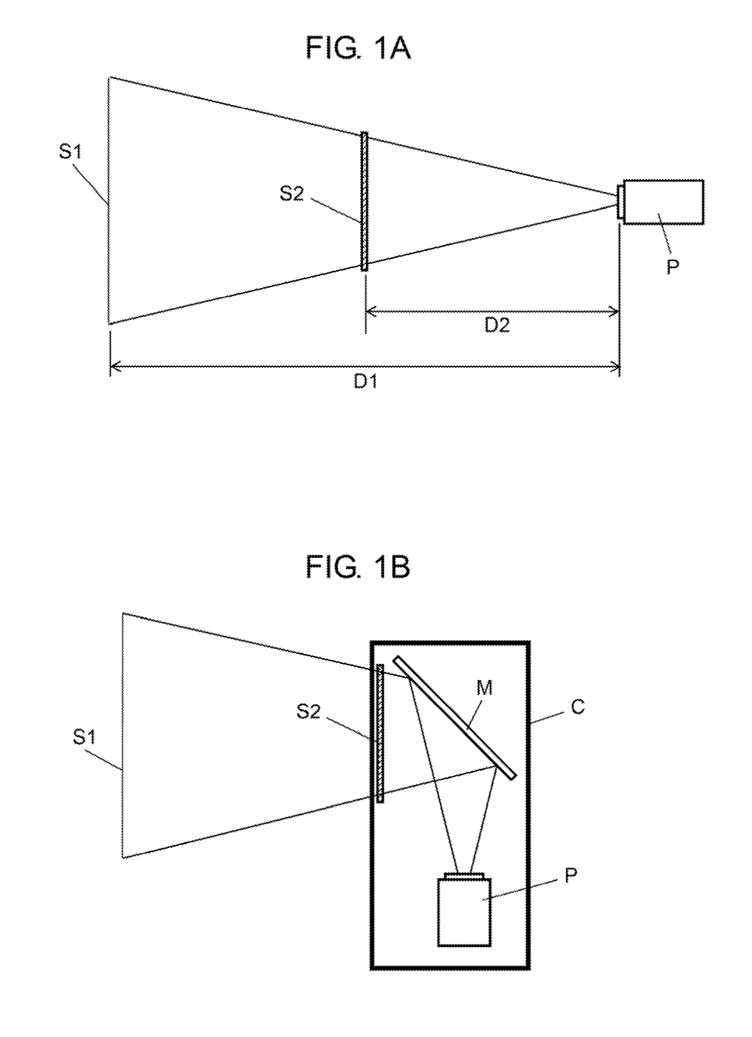

Preferred embodiments of the present invention are specifically described below with reference to FIG. 1 through FIG. 22. In the following explanation, it is called ON when the power source is turned on, and OFF when the power source is turned off.

### First Exemplary Embodiment

First of all, a basic concept about devising an image display device in this preferred embodiment of the present invention is explained by referring to FIG. 1A and FIG. 1B. The present invention relates to an image display device realized by using an image display unit of front projection type as a rear projection type, and the image display unit is a front projection type projector generally used as an indoor magnified display device. As shown in FIG. 1A, front projection type projector P has a device specification capable of projecting and displaying an image at a specified luminance (standard luminance: for example, K1) on screen S1 of specified dimension (standard dimension) at specified projection distance (standard projection distance) D1.

In this case, when the projection distance to projector P is changed from D1 to D2, the dimension of the image projected on screen S2 at projection distance D2 is smaller in proportion to the projection distance, and the display area of the image is contracted in proportion to a square of the projection distance on screen S1.

On the other hand, the luminance of the display image on screen S2 increases in inverse proportion to a square of the projection distance, as compared with standard luminance K1 when projected on screen S1. Therefore, by accommodating indoor front projection projector P and screen S2 of a dimension suited to the application in the casing, and composing the casing by disposing projector P and screen S2 so that the projection distance of projector P on screen S2 may be D2, the image display device can be realized at a higher luminance and in a smaller size than the indoor front projection type projector or the rear projection type projector.

FIG. 1B shows an example of configuration of the image display device of a smaller size and a higher luminance realized by the method mentioned above. In this example, screen S2 is disposed on the front upper side of casing C of vertical shape, and projector P of front projection type is disposed upward in the lower part of casing C, and mirror M is disposed, and thereby the projection route of projector P is changed from the vertical direction to the longitudinal direction of the device. As a result, the depth of the image display device is shortened, and the convenience of use is enhanced.

Projector P may be, for example, a standard indoor projector capable of projecting and displaying a projection image of 200 inches at a luminance of 500 candelas per square. meter. In this case, in an image display device mounting a 50-inch screen S2, the projection distance is 50/200=¼, and, as mentioned above, since the luminance increases in inverse proportion to a square of the distance, the luminance is increased 16 times, that is, 8,000 candela per square meter, and the image display device is sufficiently high in luminance for outdoor use.

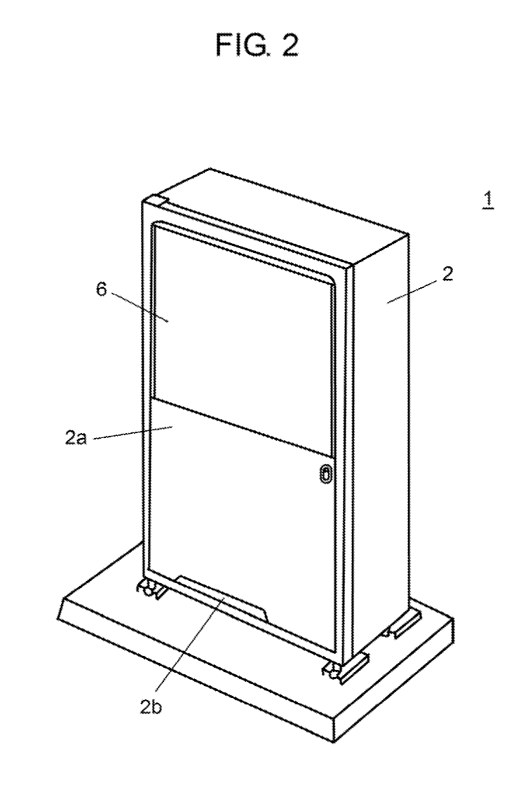

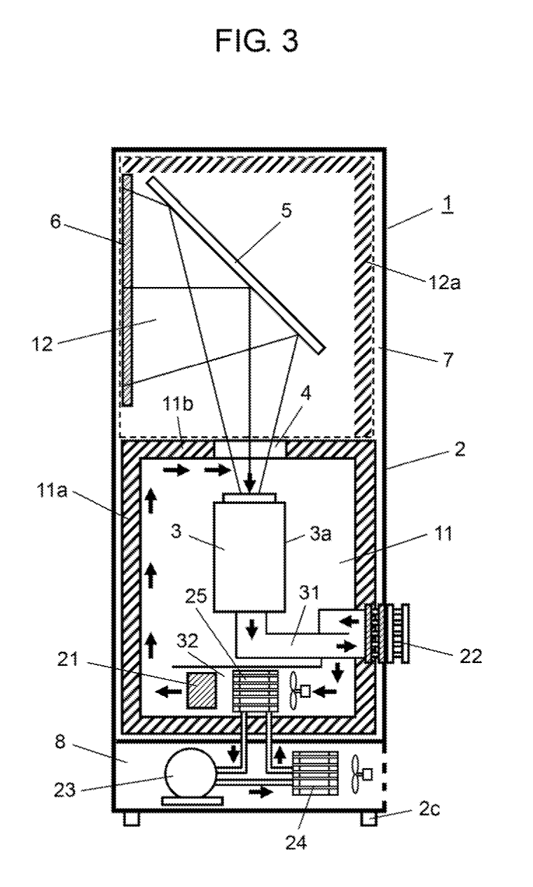

A basic configuration and functions of the image display device in the preferred embodiment of the present invention are described while referring to the drawings. FIG. 2 is a perspective view showing an outline of image display device 1 (hereinafter referred to as “this device 1”) in the preferred embodiment of the present invention, and FIG. 3 is a layout diagram showing a principal configuration of this device 1.

As shown in FIG. 2, this device 1 includes casing 2, and has door unit 2a attached to the front part of casing 2 as a structural feature, and a window part is provided in the upper part of door unit 2a so as to observe screen 6, and ventilation port 2b is disposed in the lower part of door unit 2a.

This device 1 has projector unit 3 of projection type (hereinafter referred to as “projector 3”) as an image display unit provided inside of casing 2, together with window 4, mirror 5, and transmission type screen 6, and the image information issued from projector 3 is projected on screen 6 by way of window 4 and mirror 5, so that the image can be displayed on a wide screen. A personal computer or other information processing device (not shown) is connected to projector 3, and information necessary for information presentation service is accumulated, or information can be acquired from outside by way of a communication circuit.

Other structural features of this device include a casing in which a heat insulating part is disposed, an image display unit, a screen for displaying the image issued from the image display unit, and a cooling part for cooling the inside of the casing, and the heat insulating part has a first heat insulating part disposed in a peripheral part of the image display unit for insulating from heat, and a second heat insulating part disposed in a peripheral part of the screen for insulating from heat.

Principal elements and functions for configuring this device 1 are explained below.

Casing 2 is divided into accommodation part 7 in an internal closed structure, and drive unit 8. In accommodation part 7, first heat insulating part 11, and second heat insulating part 12 are disposed. First heat insulating part 11 is formed in a box, in which window 4 is incorporated in first heat insulating member 11a, and is provided with projector 3 and heater 21 having the surrounding covered with cover 3a as external armor casing in the inside.

Second heat insulating part 12 has second heat insulating member 12a disposed and formed at both sides of the inside and at an inner side of the backside of casing 2 in peripheral parts of mirror 5 and screen 6 disposed for magnifying and projecting the image information issued from projector 3. Further, in accommodation part 7, first heat insulating member 11a is disposed by covering projector 3, and heat exchanger 22 is disposed in a state closed with casing 2.

First heat insulating part 11 is disposed for cooling projector 3 as heat source, and has a function of preventing the cold air supplied from evaporator 25 from dissipating to the surrounding, and is effective to enhance the cooling efficiency of projector 3. First heat insulating part 11 has the outer circumference of first heat insulating member 11a covered with plate member 11b of a thin plate form, and first heat insulating part 11 and second heat insulating part 12 are divided by a wall surface, and the material of first heat insulating member 11a is preferably foamed urethane or the like, and the material of window 4 is a laminated glass material or the like.

Second heat insulating part 12 is disposed for the purpose of preventing mirror 5 and screen 6 from being heated when casing 2 is exposed to solar heat or the like, and has a function of shutting off heat transmission to the inside of casing 2, and is effective for suppressing the temperature rise of the members relating to magnification and projection of image information issued from projector 3. Foamed urethane or the like is used for second heat insulating member 12a of second heat insulating part 12, and a black member of high degree of radiation is used on the inside surface for absorbing visible light. As a result, second heat insulating part 12 is effectively cooled, and the contrast of the display image is raised, and the image quality is enhanced.

Heater 21 is disposed for the purpose of controlling the temperature of this device 1, when the temperature of a specified location of this device 1 becomes lower than a specified operation temperature, by operating heater 21 and raising the temperature to the specified operation temperature. In this configuration, this device 1 can be used in a low temperature environment. Therefore, the operation temperature range of this device 1 can be expanded. The temperature is detected by a thermal sensor (not shown) installed inside of first heat insulating part 11.

Drive unit 8 in the lower part of the casing of this device 1 is provided with an air conditioner and a power source unit (not shown), and the air conditioner includes compressor 23, condenser 24, and evaporator 25, and evaporator 25 is tightly closed and disposed in first heat insulating part 11, and is designed to cool the air in the inside of first heat insulating part 11.

In the circulation cycle of the air conditioner, first, a refrigerant gas is compressed to a high temperature by compressor 23, and sent into condenser 24 (fin of aluminum structure). Inside condenser 24, the refrigerant gas is cooled and liquefied by a fan, and is sent into evaporator 25, and in the inside of evaporator 25, the liquefied gas is evaporated while depriving the surrounding of heat of vaporization, thereby cooling the fin of aluminum structure.

As described above, this device 1 has means for cooling the inside of first heat insulating part 11, that is, the air conditioner has a first cooling part including compressor 23, condenser 24, and evaporator 25, and heat exchanger 22 as a second cooling part having a heat exchange function by heat conduction. Heat exchanger 22 may be realized by a heat sink, a heat pipe, an air type heat exchanger, or the like.

As a feature about cooling procedure, cooling routes 31, 32 of air are formed by partition plates, in order to cool projector 3, in which the air heated in the inside of projector 3 by the air conditioner is guided out of cover 3a, and the guided exhaust heat is released to the outside of casing 2 by heat exchanger 22, thereby cooling secondarily by way of a cooling region by the an conditioner. In FIG. 3, the cooling routes of the an emitted from projector 3 are indicated by arrows.

Casing 2 of this device 1 is provided with casters 2c for moving on the floor, and hence this device is portable. Therefore, this device 1 can be changed in direction, or moved in position, and the convenience is enhanced in the installation and maintenance of this device 1.

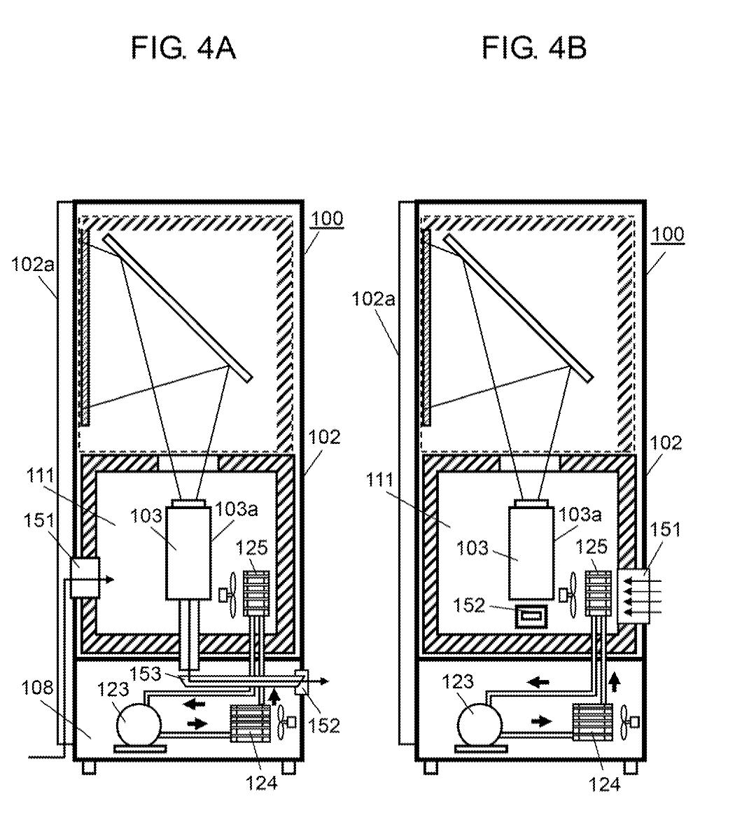

Application examples about the configuration of this device are explained by referring to FIG. 4A and FIG. 4B.

FIG. 4A and FIG. 4B are principal layout diagrams showing a basic configuration of application examples about the configuration of projector 3. The configuration of first and second heat insulating parts is same as shown in FIG. 3, and some of the reference numerals are omitted.

Casing 102 of this device 100 is not built in a closed structure, and intake port 151 and exhaust port 152 are provided in casing 102, and air is sucked in from intake port 151 by way of ventilation port (ventilation port 2b in FIG. 2) provided in the lower part of door unit 102a, and the inside of first heat insulating part 111 is cooled by an air conditioner composed of compressor 123, condenser 124, and evaporator 125, and the air heated in projector 103 is exhausted from exhaust port (not shown) provided in cover 103a of projector 103, and exhausted to the outside by way of exhaust port 152 provided in casing 102 of this device 100.

Casing 102 is not of closed structure, but a filter is provided in intake port 151, and invasion of dust can be prevented. The filter is specifically described later.

FIG. 4A shows an example of disposing intake port 151 in the front part of this device 100, and disposing exhaust port 152 in the rear part, and FIG. 4B shows an example of disposing intake port 151 in the rear part of this device 100, and exhausting the heated air from projector 103 from exhaust port 152 disposed at the lateral side of this device 100. In the example shown in FIG. 4A, evaporation pan 153 is disposed in drive unit 108 in the lower part of the casing, and water drops generated by cooling by evaporator 125 are discharged into evaporation pan 153. Hence, by the exhaust heat exhausted from projector 103, the water drops collected in evaporation pan 153 can be evaporated.

This configuration, as compared with the closed structure of the casing, is simplified in structure because it is not required to dispose a heat exchanger for releasing heat to outside, and is effective to reduce the cost.

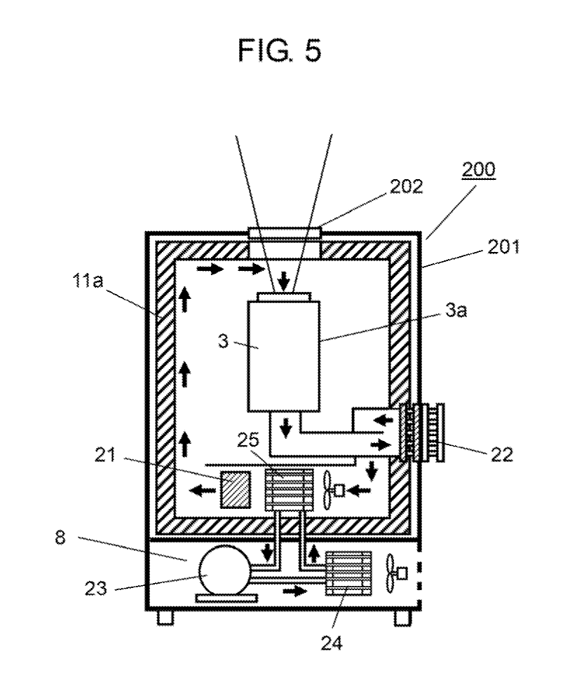

As an application example about the use of this device 1, first heat insulating part 11 in FIG. 3 is separated from second heat insulating part 12, and is contained in casing 201 having window 202 together with drive unit 8 as shown in FIG. 5, so that image display device 200 of front projection type is realized.

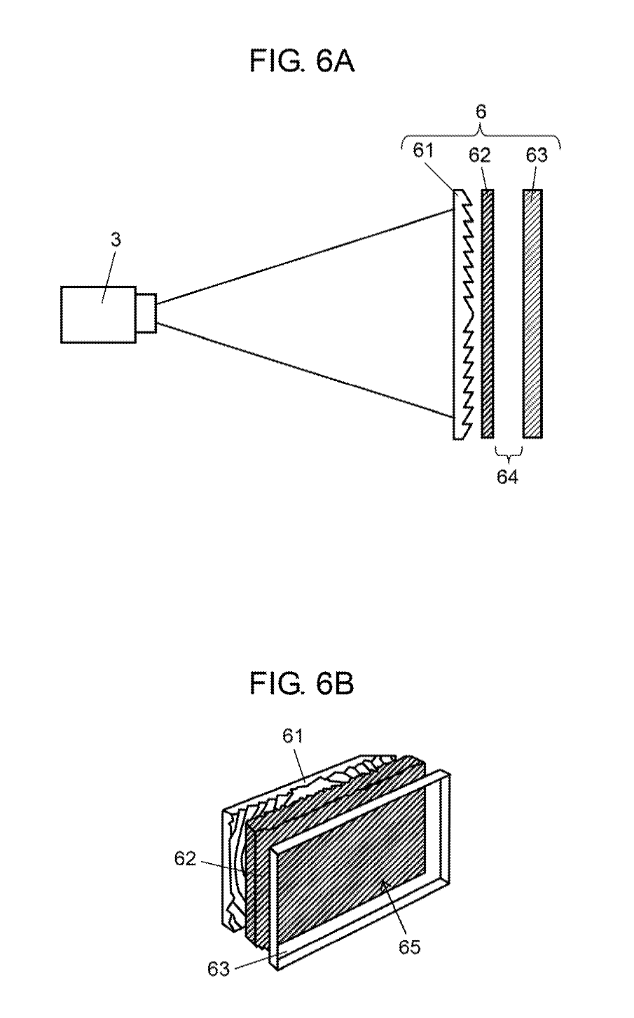

Next, various countermeasures about the ambient environment when this device 1 is installed, and the configuration and the function of this device 1 are explained below referring to FIG. 6 through FIG. 16.

In FIG. 6A and FIG. 6B, first of all, a specific configuration of screen 6 shown in FIG. 3 is described. FIG. 6A and FIG. 6B are a sectional view and a perspective view respectively showing a detailed configuration of screen 6 of the present preferred embodiment. In FIG. 6A and FIG. 6B, screen 6 has Fresnel lens 61, diffusion plate 62, and front protective panel 63. Further, as shown in FIG. 6A, at a side opposite to projector 3, Fresnel lens 61, diffusion plate 62, and front protective panel 63 are disposed in this order.

Fresnel lens 61 is composed by forming lenses concentrically in a saw-tooth section, and has an action of concentrating the diverging projection light to the observer's side. Diffusion plate 62 is made of acrylic resin or other transparent base material, and is mixed with one or plural types of fine particles different in refractive index from the base material as scatter particles, and is formed like a plate member for diffusing the projection light. Or it is formed like a sheet member.

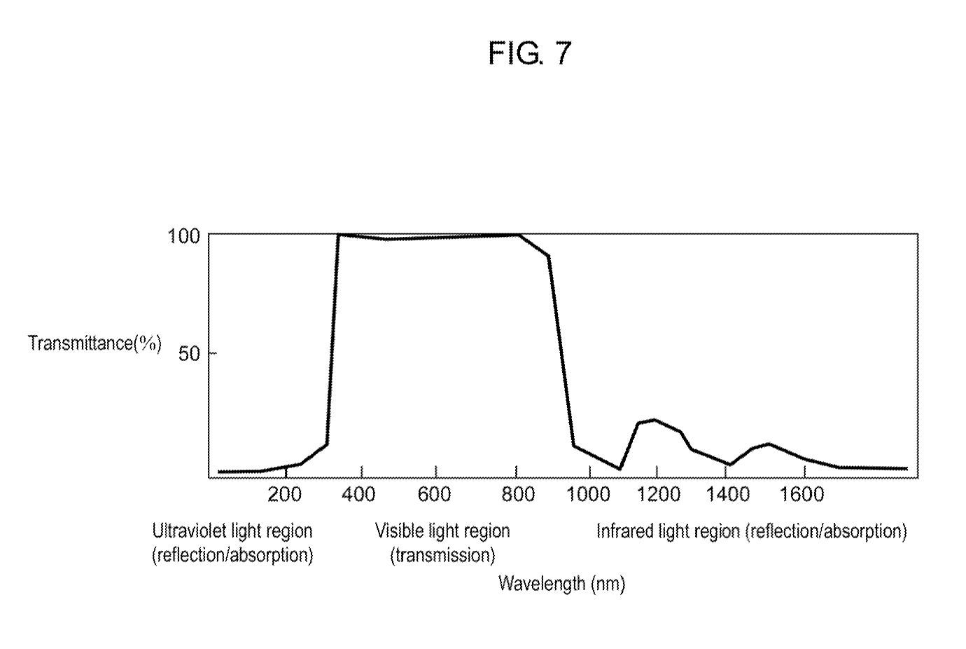

Front protective panel 63 is a plate member formed of a transparent base material. The material for the transparent base material includes, for example, glass, acrylic resin, polycarbonate resin, and others, and not limited to transparent materials, other materials high in physical strength and excellent in property to be formed into a plate form may be suited. Front protective panel 63 also contains a tinting material for absorbing visible light partially. In particular, characteristics to ultraviolet light and infrared light are considered, and the structure and the material composition for absorbing or reflecting individual wavelength components are employed. FIG. 7 shows an example of optical characteristic relating to the transmittance of front protective panel 63. As shown in FIG. 7, in a visible light region, the transmittance is nearly 100%, but in an ultraviolet light region of shorter wavelength or in an infrared light region of longer wavelength, the transmittance is lowered extremely. Owing to this characteristic, front protective panel 63 has a function of passing only the visible light, and reflecting or absorbing the light in the ultraviolet light region and in the infrared light region. Moreover, an anti-static paint is applied to the exposed surface on the outside of casing 2 of front protective panel 63. The coating method includes coat spraying or ion shower coating method. In this configuration, electrostatic charging of front protective panel 63 is prevented, and the exposed surface of the outside of casing 2 of screen 6 will not be charged electrically. Therefore, the image display device of the present preferred embodiment is free from sticking of charged foreign matter on the surface of screen 6, and the surface of screen 6 can be maintained in a clean and stainless state, and a display screen of high quality can be presented.

Diffusion plate 62 and front protective panel 63 are disposed at a specified spacing distance, and this space forms a free space (air passing layer 64) for passing air freely. The specified distance is not particularly specified as far as natural convection of air or forced cooling is allowed without using any adhesive material between front and rear members. Thus, as described above, since screen 6 disposed in this device 1 has front protective panel 63 of a plate material of high physical strength, if this device 1 is installed outdoors, screen 6 can be protected from physical damages.

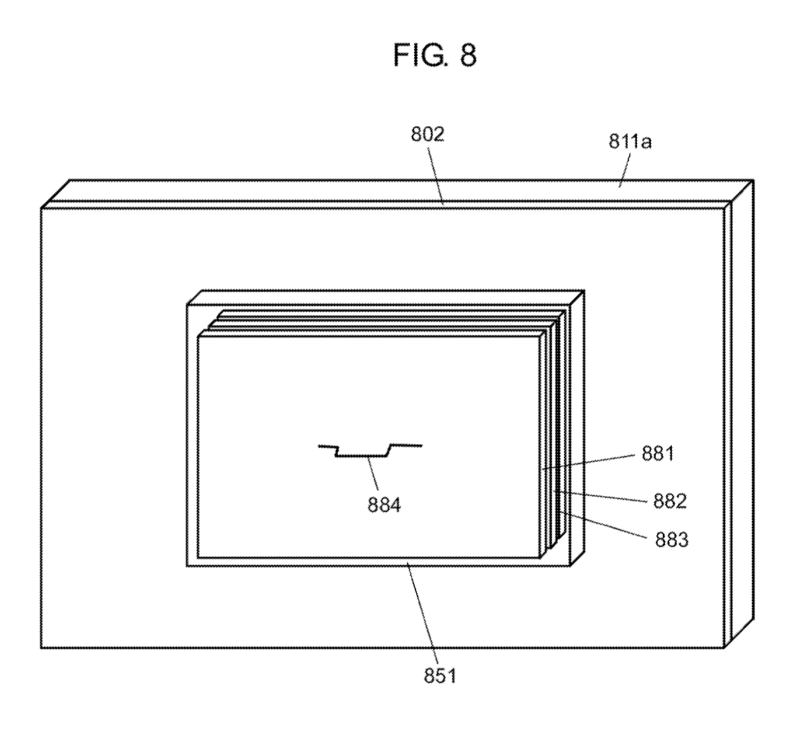

Referring then to FIG. 8 through FIG. 10, dust preventive measures of this device 100 are explained.

FIG. 8 shows a specific configuration of intake port 151 provided at the front part of casing 102 of this device 100. As shown in FIG. 8, at the outer side of intake port 151 disposed in the front part of casing 102 having heat insulating material 811a at the inner side, dust filters 881, 882, 883 of different mesh sizes are disposed detachably in batch by means of handle 884. Therefore, filters 881, 882, 883 can be detached appropriately, and dust can be removed. A similar configuration may be applied in exhaust port 152 disposed in the rear part of casing 102 shown in FIG. 4.

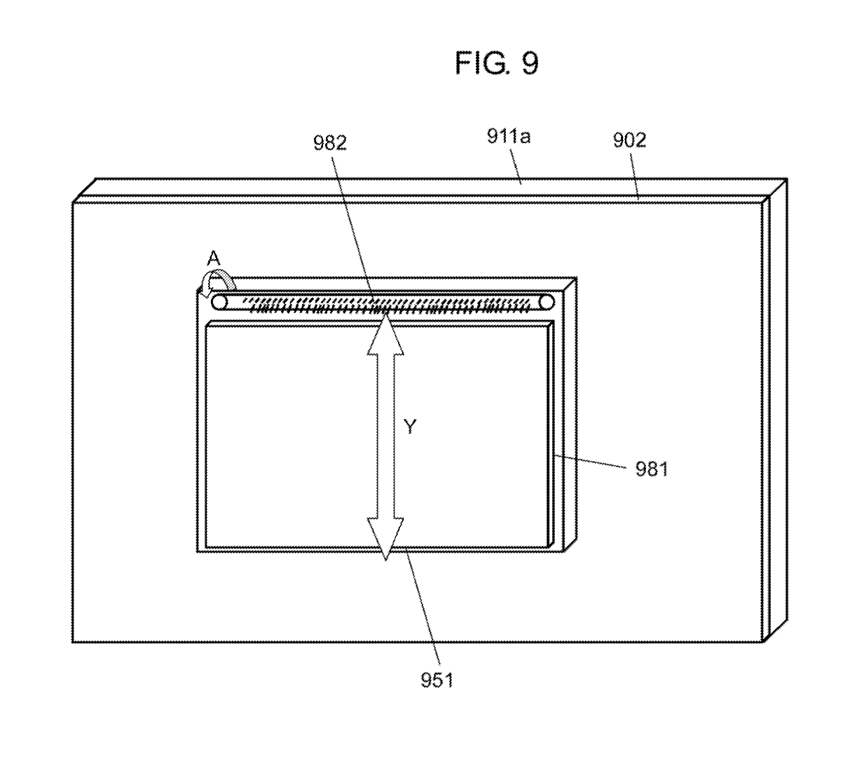

FIG. 9 shows, relating to filter 981 disposed at intake port 951, showing an example of adding a function for removing dust deposits automatically. Intake port 951 is provided with cleaner 982 of rotary type. On the rotation surface of cleaner 982, a brush-like sliding member is formed, and it moves at a specific speed in a vertical direction (Y-direction) in contact with the surface of filter 981 while rotating in direction A at specific time intervals. As a result, filter dust deposits can be removed appropriately.

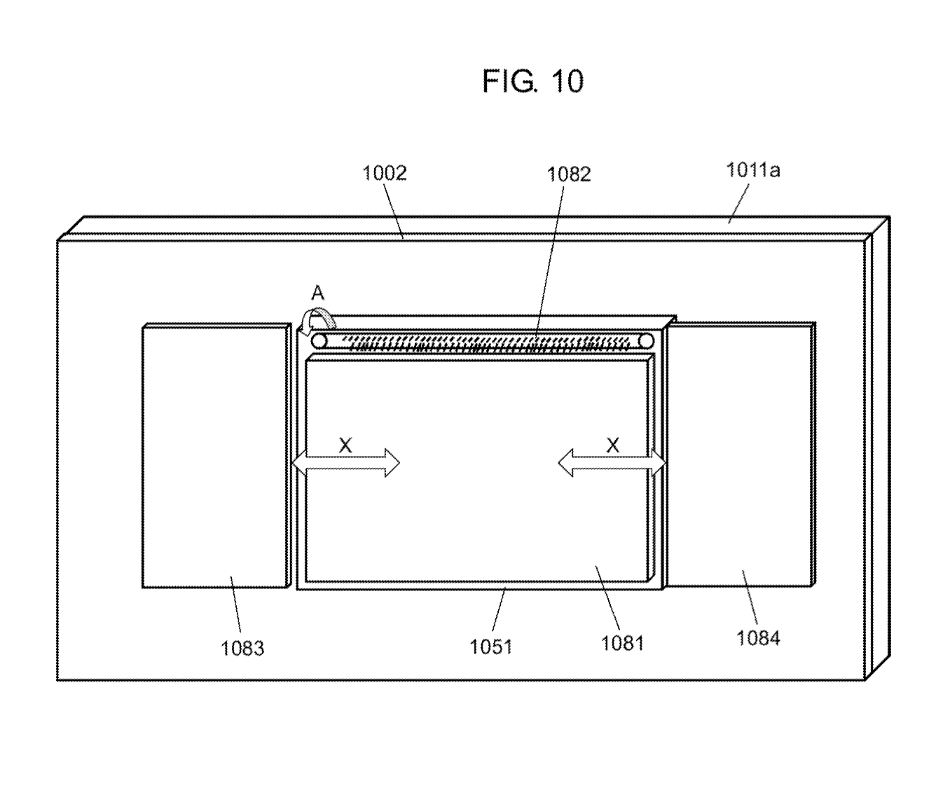

FIG. 10 shows an application example of the configuration shown in FIG. 9, and more specifically intake port 1051 provided at the front part of casing 1002 having heat insulating member 101a at the inside can remove dust deposits from filter 1081 by way of cleaner 1082, and also shutters 1083, 1084 are provided. Shutter 1083 and shutter 1084 can be moved respectively in right and left direction (X-direction). Hence, in this device 100, by interlocking with shut-off of power source, by driving shutter 1083 and shutter 1084, intake port 1051 can be closed.

In exhaust port 152 shown in FIG. 4, also, the configuration shown in FIG. 9 and FIG. 10 can be similarly applied. Further, same effects can be obtained by disposing a screen shutter in the window area of door unit 2a of casing 2 shown in FIG. 2.

Moreover, by providing casing 2 or screen 6 shown in FIG. 2 with anti-static means, sticking of dust may be suppressed, and the dust preventive effect may be further enhanced by combining with the countermeasures shown in FIG. 8 through FIG. 10.

Thus, in this configuration, by dust filter provided at the intake port of this device 100, invasion of dust can be prevented. Further, electrostatic charging of the casing can be prevented, and the casing is free from dust deposits due to electrostatic charging. Therefore, this device 100 is free from dust and foreign deposits due to electrostatic charging, and invasion of dust and foreign matter into the casing can be prevented, and an image display device excellent in weather resistance and durability that can be installed in a dusty and sooty outdoor environment can be realized.

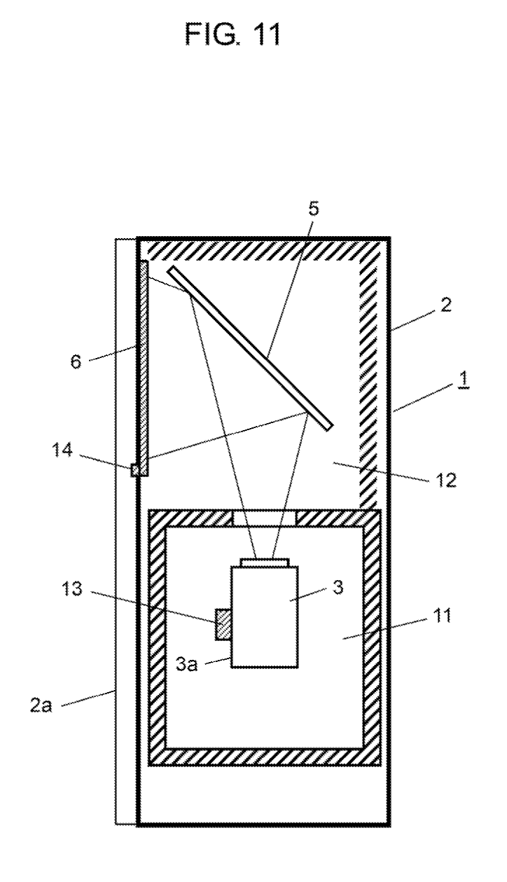

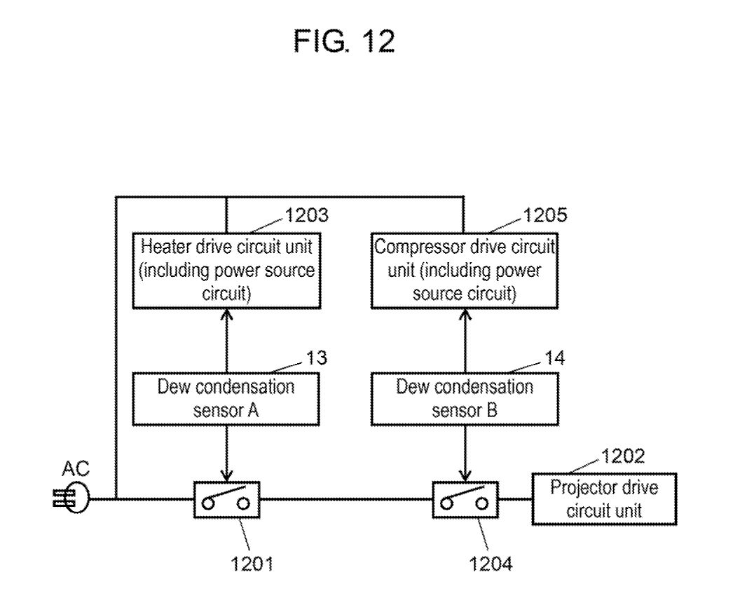

Referring now to FIG. 11 and FIG. 12, a configuration of dew condensation countermeasure of this device 1 is described. FIG. 11 shows an example of adding a dew condensation countermeasure to this device 1 shown in FIG. 3. The basic configuration of this device 1 is same as in FIG. 3, and the drive unit, the heating unit, the cooling part, and others are omitted in the drawing. In FIG. 11, this device 1 has dew condensation sensor 13 provided in first heat insulating part 11 disposed in the inside of casing 2. Dew condensation sensor 13 is pasted to cover 3a of projector 3, for example, as an image display unit, but the location is not limited to this example. The position of adhering dew condensation sensor 13 may be determined as a design condition. For example, aside from first heat insulating part 11, dew condensation sensor 14 may be disposed outside of screen 6, or a plurality of dew condensation sensors may be provided, so that the detection function of dew condensation may be enhanced.

FIG. 12 is a block diagram showing an example of a control circuit responsible fore dew condensation countermeasure of this device 1 when using dew condensation sensor 13 and dew condensation sensor 14. In this device 1, between an AC power source and projector drive circuit unit 1202, relay switch 1201 and relay switch 1204 are connected in series. Dew condensation sensor 13 is connected to relay switch 1201 and heater drive circuit unit (including power source circuit) 1203. Similarly, dew condensation sensor 14 is connected to relay switch 1201 and compressor drive circuit unit (including power source circuit) 1205.

In this configuration, when relay switch 1201 receives dew condensation information from dew condensation sensor 13, the power source of projector drive circuit unit 1202 is turned off, and the power source circuit of heater drive circuit unit 1203 is turned on to operate heater 21 (not shown), and first heat insulating part 11 in which dew condensation is detected is heated, and dew condensation can be resolved. Or if dew condensation sensor 14 detects dew condensation at the outer side of screen 6 due to low temperature of the ambient air contacting with the outer side of screen 6, the power source of projector drive circuit unit 1202 is turned off, and, instead of the heater, compressor drive circuit unit 1205 is operated, and cooling of second heat insulating part 12 is started, and the inside of screen 6 is cooled, and thereby dew condensation can be resolved. Meanwhile, in cooperation with the power source OFF operation of this device 1, by closing the intake port and exhaust port (not shown) of casing 2, invasion of water or moisture into casing 2 can be suppressed, so that the effect of dew condensation countermeasure can be enhanced.

As mentioned above, this device 1 is characterized by controlling and driving of this device 1 on the basis of the information relating to humidity changes in the inside and the outside of casing 2. More specifically, when the dew condensation sensor detects dew condensation, the power source of the projector as the image display unit is turned off, and if the heating part or the cooling part is operated while dew condensation is being detected by the dew condensation sensor, and when the dew condensation is resolved, the power source of the projector is turned on. Therefore, if the humidity changes in the inside or outside of casing 2, by driving and controlling this device 1, this device 1 is not operated during dew condensation, and the countermeasure of dew condensation is secure. As a result, malfunction of this device 1 due to dew condensation can be prevented, and an image display device of high quality that can be installed in various outdoor environments can be realized.

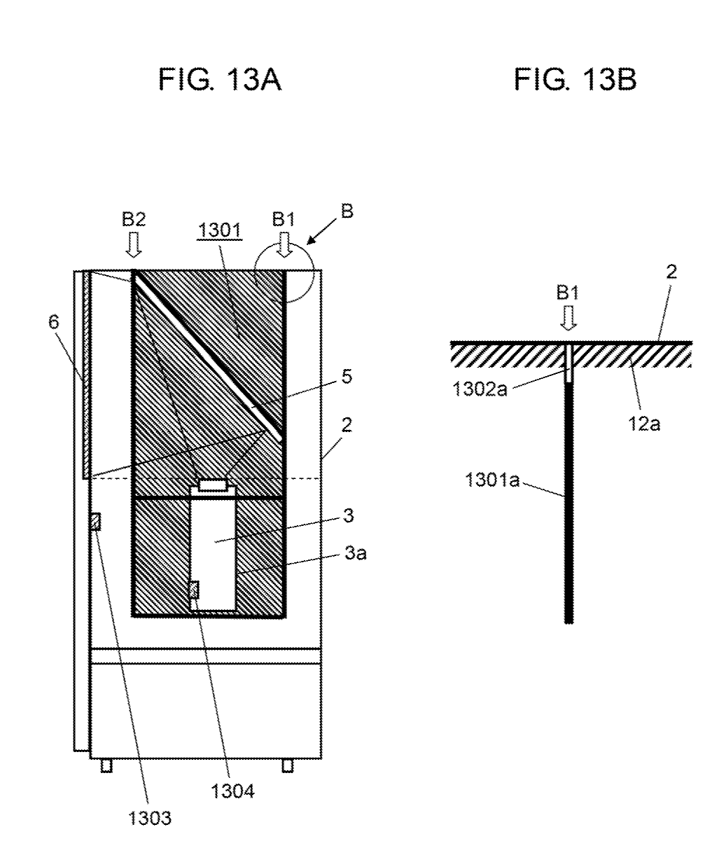

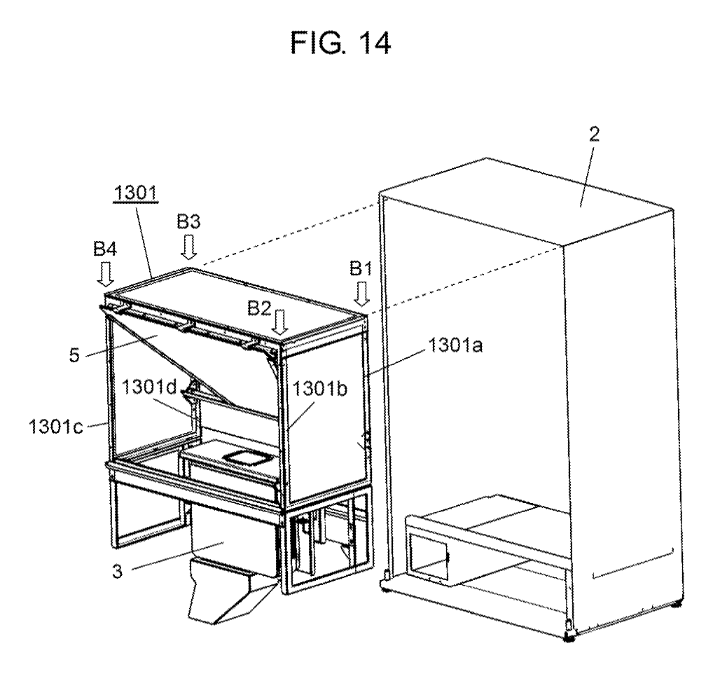

Next, referring to FIG. 13A, FIG. 13B and FIG. 14, a configuration about vibration countermeasure of this device 1 is explained below. FIG. 13A, FIG. 13B and FIG. 14 are respectively a principal layout diagram, a partial magnified view, and a perspective view showing the configuration about vibration countermeasure of this device 1.

As shown in FIG. 13A, FIG. 13B and FIG. 14, in this device 1, the holding part of the compressor is fixed to casing 2 by means of vibration-proof rubber or the like, and vibration countermeasures are provided against vibration sources (not shown particularly), and in addition, a vibration-proof structure is provided for preventing oscillation of image for display image projected on screen 6. In particular, projector 3 and mirror 5 including an optical engine are supported in a suspension structure as shown in FIG. 13A. Projector 3 and mirror 5 are fixed and held in suspension structural body 1301 assembled in a hollow box shape made of L-shaped members or the like. Specifically, suspension structural body 1301 is suspended from the ceiling of casing 2 by way of vibration absorption member 1302a at four positions B1 to B4 in the upper part.

FIG. 13B is a partial sectional view showing a specific configuration of part B in FIG. 13A, in which one suspension angle 1301a out of four suspension angles 1301a to 1301d for composing suspension structural body 1301 is suspended from the ceiling of casing 2 by way of vibration absorption member (buffer member) 1302a made of vibration-proof rubber or the like. The other suspension angles 1301b to 1301d have a similar structure. In this configuration, a vibration-proof structure may be disposed in the holding parts of the image display unit and the compressor. It is hence effective to prevent oscillation of display image on screen 6 due to vibrations occurring in projector 3 or compressor 23 (FIG. 3) included in the image display device. As a result, an image display device of high quality free from oscillation of display image that can be installed outdoors can be realized.

Meanwhile, by providing the optical system ranging from projector 3 to screen 6 with vibration-proof measures, oscillation of display image on screen 6 can be more effectively prevented.

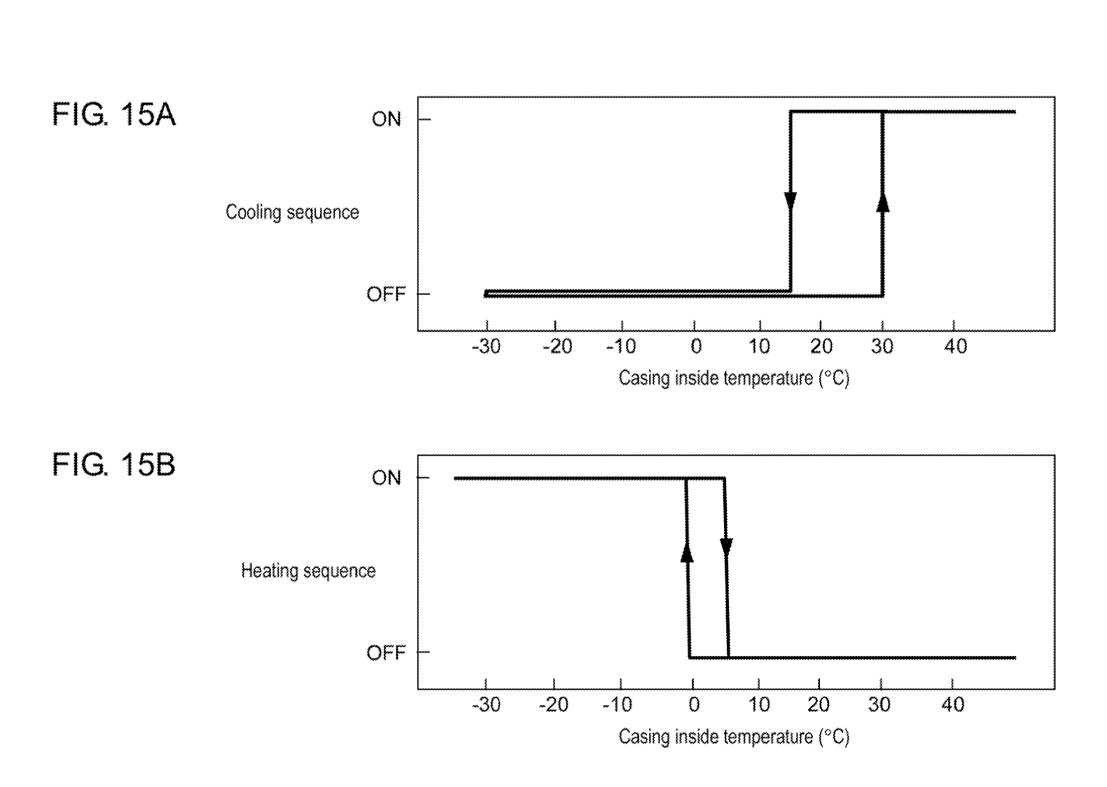

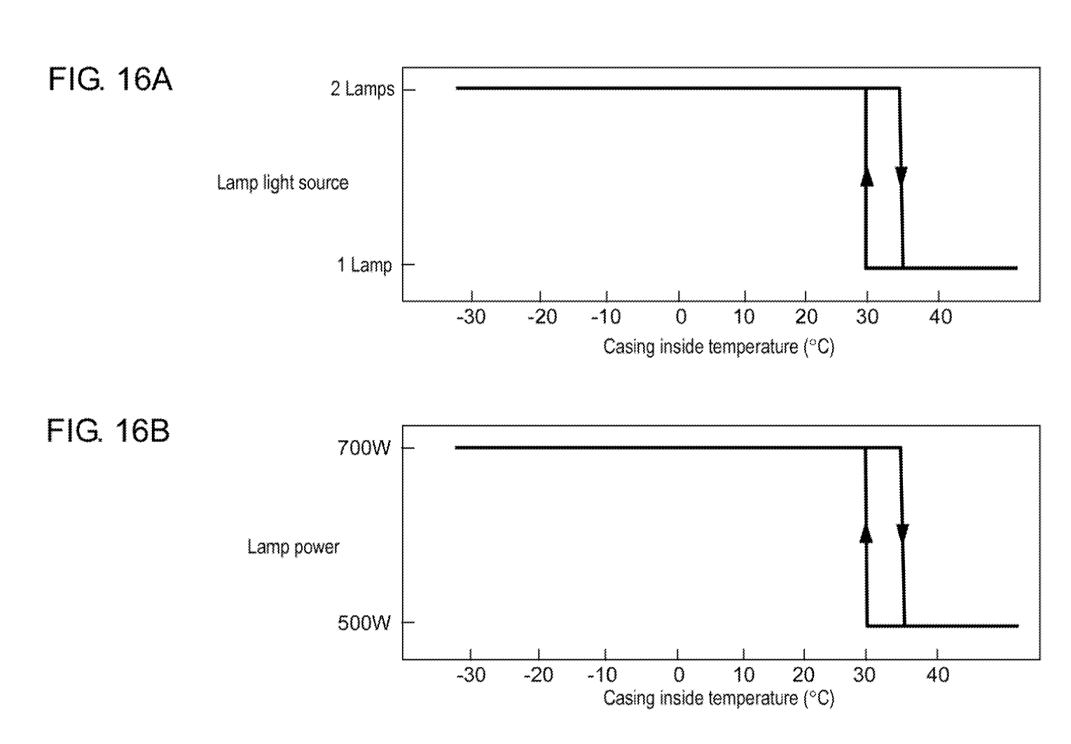

Next, by referring to FIG. 13A, FIG. 13B, FIG. 15A, FIG. 15B, FIG. 16A, and FIG. 16B, a configuration about drive control of this device 1 is explained.

First, this device 1 can drive and control the image display device on the basis of the information about temperature changes in the inside of casing 2. First thermal sensor 1303 is provided in the inside of casing 2 of this device 1, and second thermal sensor 1304 is provided in the inside of cover 3a of projector 3, and when the temperature detected by first thermal sensor 1303 is higher than a specified temperature, compressor 23 (FIG. 3) is put in action as the cooling part, and when becoming lower than the specified temperature, the power source of projector 3 can be turned on. When the temperature detected by first thermal sensor 1303 is lower than the specified temperature, heater 21 (FIG. 3) is put in action as the heating part, and when becoming higher than the specified temperature, the power source of projector 3 can be turned on.

Moreover, when the temperature detected by second thermal sensor 1304 is higher than a specified temperature, by controlling the light source of projector 3 to change from lighting of two lamps to that of one lamp, heat generation of projector 3 can be suppressed. Or without changing the number of lamps of projector 3, by controlling the electric power (lamp power) to be supplied to the light source, heat generation of projector 3 may be suppressed. In other method, further, means for detecting the operation rate of the compressor may be provided, and since the operation rate of the compressor is higher when the internal temperature of casing 2 is higher, the number of lit lamps or the supply power to the light source can be controlled depending on the operation rate of the compressor, so that heat generation of projector 3 may be suppressed.

FIG. 15A and FIG. 15B show the relation between the internal temperature of casing 2 in this device 1 (referred to as “casing insidetemperature” in FIG. 15A, FIG. 15B, FIG. 16A, and FIG. 16B) and the cooling and heating sequence, and FIG. 16A and FIG. 16B show the relation between the number of lit lamps of the light source of projector 3, and the casing inside temperature when the power lamp is controlled.

Referring to FIG. 15A, control of cooling sequence is explained. When the power source of this device 1 is turned on, the temperature in casing 2 continues to climb up, and when the detection temperature of thermal sensor 1303 reaches, for example, 30° C.; the compressor is put in action, and begins to cool the inside of the casing. On the other hand, in the nighttime, when the ambient temperature declines and the detection temperature of thermal sensor 1303 becomes, for example, lower than 15° C., the compressor stops its operation, and cooling is finished. In this manner, it is preferred to allow a hysteresis of a specified width (for example, 15° C.) in the temperature threshold between start and end of operation of the compressor. This is because if start and end of operation of the compressor (ON and OFF of the power source of the compressor) are controlled at a specific temperature, start and end of operation occur frequently, and the temperature control in casing 2 becomes unstable. Due to the same reason, this hysteresis control is executed also in other objects of control (heating sequence, lamp light source, lamp power), but the explanation is omitted in order to avoid repeated descriptions.

In this device 1, projector 3 is driven and controlled on the basis of the information relating to illumination changes outside of casing 2. For example, by disposing an illumination sensor (not shown) in casing 2, the luminance of the display screen of screen 6 can be controlled depending on the illumination of screen 6. Further, by providing this device 1 with a timer, the luminance of the display screen of screen 6 can be lowered automatically in the nighttime.

Therefore, if the inside temperature of casing 2 is changed due to environment of installation or state of operation of this device 1, by driving and controlling this device 1 appropriately, the inside of casing 2 can be maintained within a specified temperature range. As a result, the operation of this device 1 is stabilized, and an image display device of high quality that can be installed in various outdoor environments can be realized.

Similarly, if the humidity is changed, by driving and controlling this device 1 appropriately, operation is avoided during dew condensation, and secure dew condensation countermeasures are possible. Thus, malfunction of this device 1 due to dew condensation can be prevented, and the safety of this device 1 is assured.

Similarly, if the illumination is changed, by driving and controlling this device 1 appropriately, the visual recognition of the display image can be maintained in a specified range. As a result, regardless of the weather, the time, the illumination condition of the place of installation, or other conditions, a display image of an appropriate luminance is maintained, and an image display device of high quality that can be installed in various outdoor environments can be realized.

The configuration of driving and controlling of this device 1 is not limited to the configuration and functions described above, but may include the following configuration and functions and may have the following effects, as measures for coping with various environments of installation promptly and effectively.

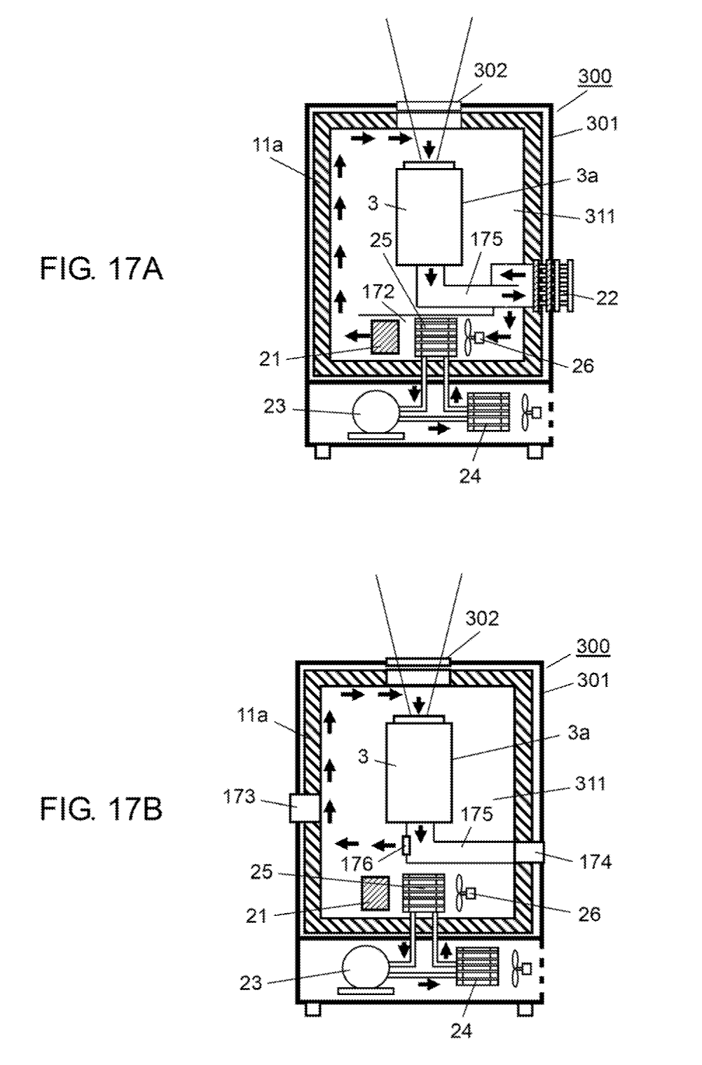

First, as shown in FIG. 17A and FIG. 17B, first heat insulating part 311 has a configuration and a function capable of circulating and utilizing the waste heat as countermeasure for low temperature. FIG. 17A and FIG. 17B are principal layout diagrams showing a circulation flow path of heat flow provided in image display device 300.

FIG. 17A is same as the configuration of this device 1 shown in FIG. 3, and in first heat insulating part 311, circulation routes 171, 172 of closed type are formed. In this configuration, as countermeasure for low temperature, operation of the cooling part (heat exchanger 22, compressor 23, condenser 24, evaporator 25) is stopped, and the heat generated by the light source of projector 3 is circulated as heat flow in first heat insulating part 311 by way of circulation routes 171, 172. In this case, by operating together with heater 21 and the fan, the circulation of the heat flow may be accelerated.

FIG. 17B shows an example about a configuration different from FIG. 17A, and intake port 173 and exhaust port 174 are provided. Ventilation port 176 having an opening-closing valve is disposed on the way of exhaust route 175 for guiding the heat generated from the light source (not shown) of projector 3 to the outside of this device 300. Therefore, by closing intake port 173 and exhaust port 174 disposing in casing 301, and opening the opening-closing valve of ventilation port 176, in first heat insulating part 311, a circulation route about exhaust heat of projector 3 can be composed (indicated by arrows).

By using the circulation route formed by disposing ventilation port 176 having the opening-closing valve, the heat flow discharged from projector 3 can be released to the closed space of first heat insulating part 311 on the way of the exhaust route. As a result, in first heat insulating part 311, the heat flow generated from the inside of projector 3 by lighting of the light source is circulated, and the inside of first heat insulating part 311 and projector 3 is rapidly and effectively heated, and the specified position of image display device 300 can be heated to a specified temperature in a short time. Meanwhile, the most important point for prevention of dew condensation of image display device 300 is projector 3. By heating projector 3 from the inside, it is effective to keep the inside of projector 3 in a state hard to condense dew.

Further, control methods of low temperature countermeasures mentioned above are described below. In this device 1, when drive measures for low temperature are necessary, the following measures can be executed.

In a first example, when the power source is turned on, by stationary control (preheat, etc.) of the device inside temperature until a specified position of the image display device reaches a specified temperature range, the image display device starts its operation according to a specified process when reaching the specified temperature range. This method is effective, in particular, when the image display device is installed in a standard place of installation.

In a second example, when the power source is turned on, at the same time, the image display device starts its operation according to a specified process. This method is effective, in particular, when the temperature of the specified position is not outside of the rated temperature range.

In a third example, when the power source is turned on, the operation is stopped only in a specified place, and by rapid control of the device inside temperature (such as fast heating) until the specified position of the image display device reaches a specified temperature range, the image display device starts its operation according to a specified process when reaching the specified temperature range. In this case, as a specific method, simultaneously when the power source of the image display device is turned on, the portion other than the optical element (DMD), in particular, the light source is put in operation. This method is effective, in particular, when the temperature of the specified position is out of the rated temperature range of the image display device (for example, less than 5° C.) (when installed, for example, in a very cold district).

In this device 1, the three control methods above can be changed over.

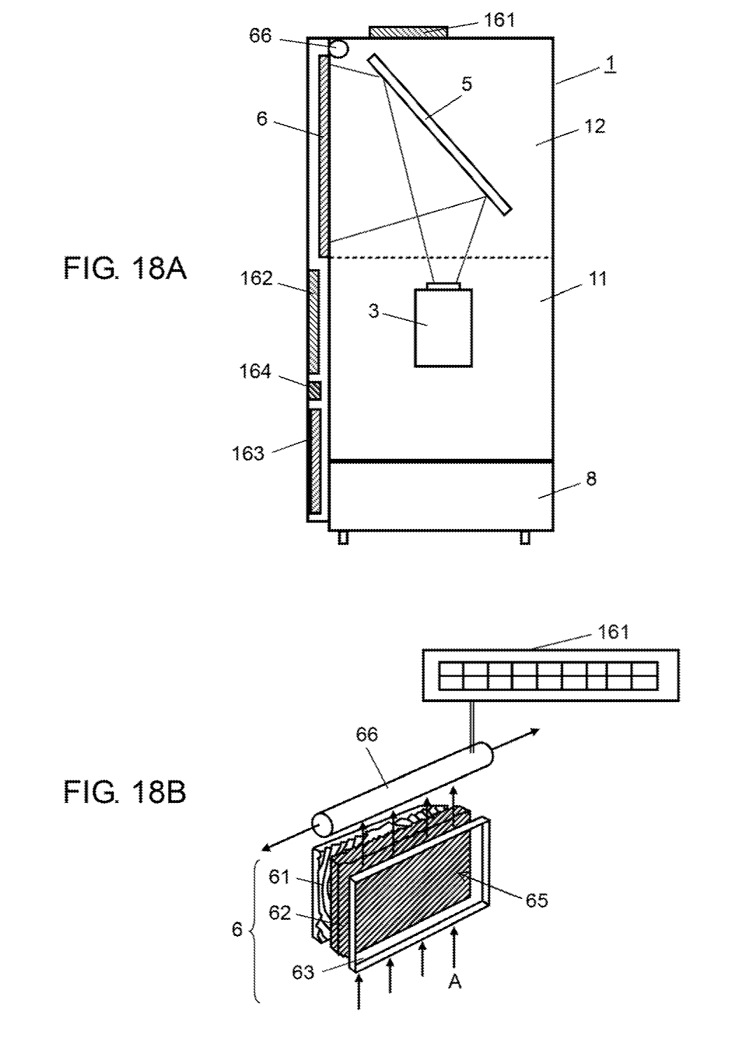

Next the configuration about safety measures of this device 1 is explained by referring to FIG. 18A and FIG. 18B.

FIG. 18A and FIG. 18B show a basic configuration of this device 1, same as in FIG. 3, and the inside of casing 2 is divided into first heat insulating part 11, second heat insulating part 12, and drive unit 8. The configuration of each part is omitted in the drawing.

As shown in FIG. 18A and FIG. 18B, the outer surface of casing 2 of this device 1, for example, the ceiling surface or the front panel (door unit) is provided with solar panels 161; 162, battery 163, and position information transmitter (GPS transmitter) 164 as self power generation parts. Second heat insulating part 12 is provided with cross fan 66 as a cooling part.

Solar panels 161, 162 have a function of generating power from sunlight, and the electric power generated by own self is supplied to cross fan 66, and other drive parts, so that they can be driven. As a result, if supply of electric power of this device 1 is stopped due to power failure, natural disaster, or incidental or intentional accident, parts particularly vulnerable to heat such as the screen or the DMD (optical element) can be cooled, and these parts are suppressed in temperature elevation and can be protected. Battery 163 is used in combination with the solar panels, and can reserve the electric power supplied from solar panels 161, 162. Therefore, if supply of electric power to this device 1 is stopped due to any reason, or in the nighttime when the electric power supply function from solar panels 161, 162 is lowered, or when a large electric power is needed temporarily, it is effective to supply the electric power.

Position information transmitter 164 is driven by battery 163, and transmits position information at specified time intervals. Position information transmitter 164 is provided with an angular velocity sensor (not shown), and when the angular velocity sensor detects a change in angular velocity by more than a specified level, abnormality is noticed by alarm sound. Therefore, if the supply of electric power is stopped, an alarm can be issued to the surrounding by detecting the move of this device 1. As a result, an image display device of high quality excellent in, emergency function in case of accident or disaster can be realized.

Besides, as shown in FIG. 18A, cross fan 66 is disposed in the upper part of the inside of screen 6 (the side opposite to mirror 5), and is put into operation when screen 6 is heated by ambient air or direct sunlight and the temperature rise exceeds a specific temperature, and thereby screen 6 is cooled. Cross fan 66 is usually driven by ordinary supply of electric power, and is also connected to solar panel 161, and can be operated by the electric power generated from the solar energy. Further, as shown in FIG. 18B, cooling wind A is passed through air communication layer 64 (FIG. 6) of screen 6, and is exhausted in the axial direction of cross fan 66, so that screen 6 can be cooled.

In such configuration, an image display device of high quality, excellent in safety, and high resistant to accident or disaster that can be installed in various outdoor environments can be realized.

As described above, by using the image display device of the present invention, in the projection type image display device using a projector, the temperature can be controlled appropriately in various cooling conditions of the mounted devices and components such as the projector and the screen, and the image display device of high precision and high luminance that can be installed in various outdoor environments can be realized. In particular, being excellent in weather resistance, it can be operated in severe ambient temperature conditions, and the image display device of high convenience usable in information presentation service such as outdoor advertising can be realized.

### Second Exemplary Embodiment

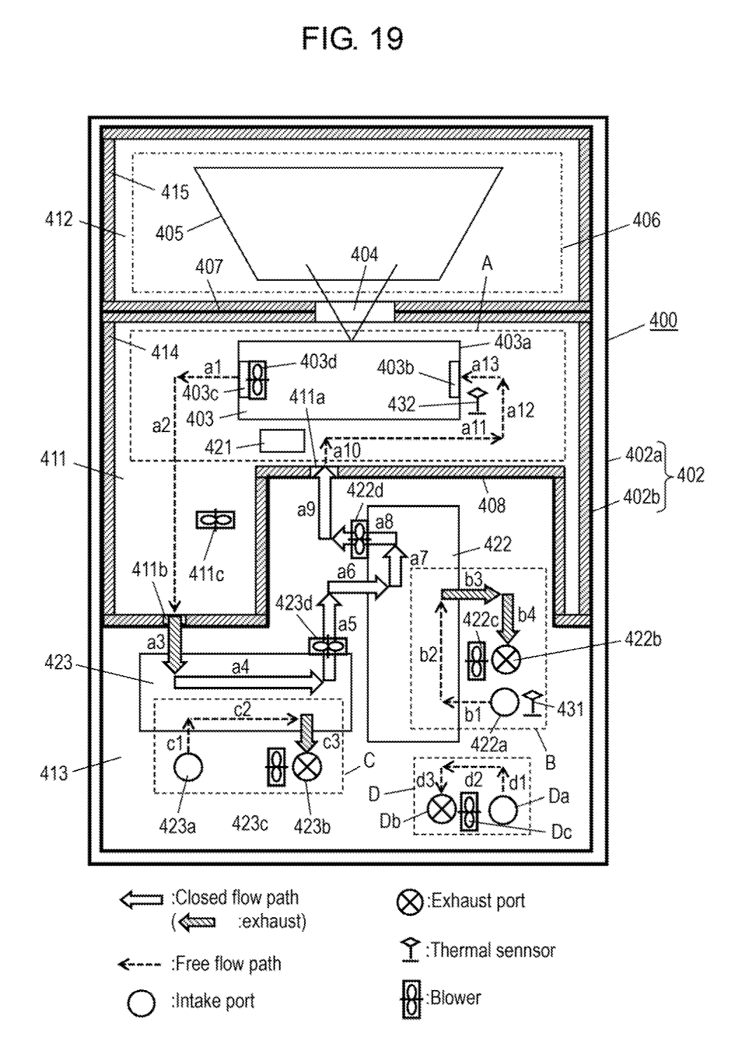

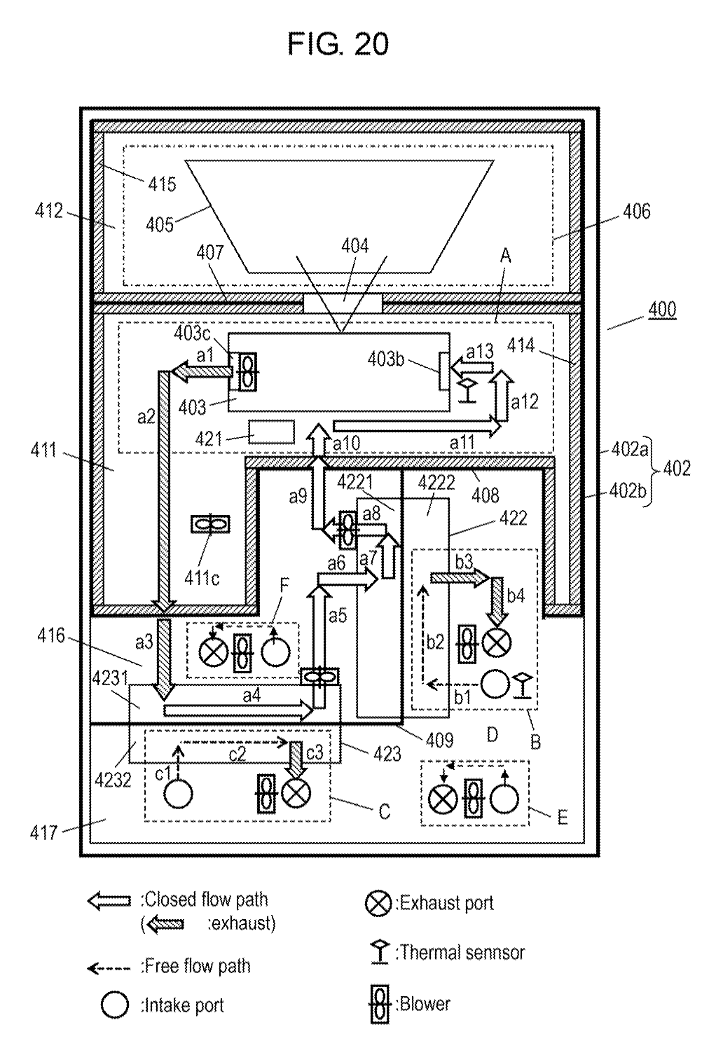

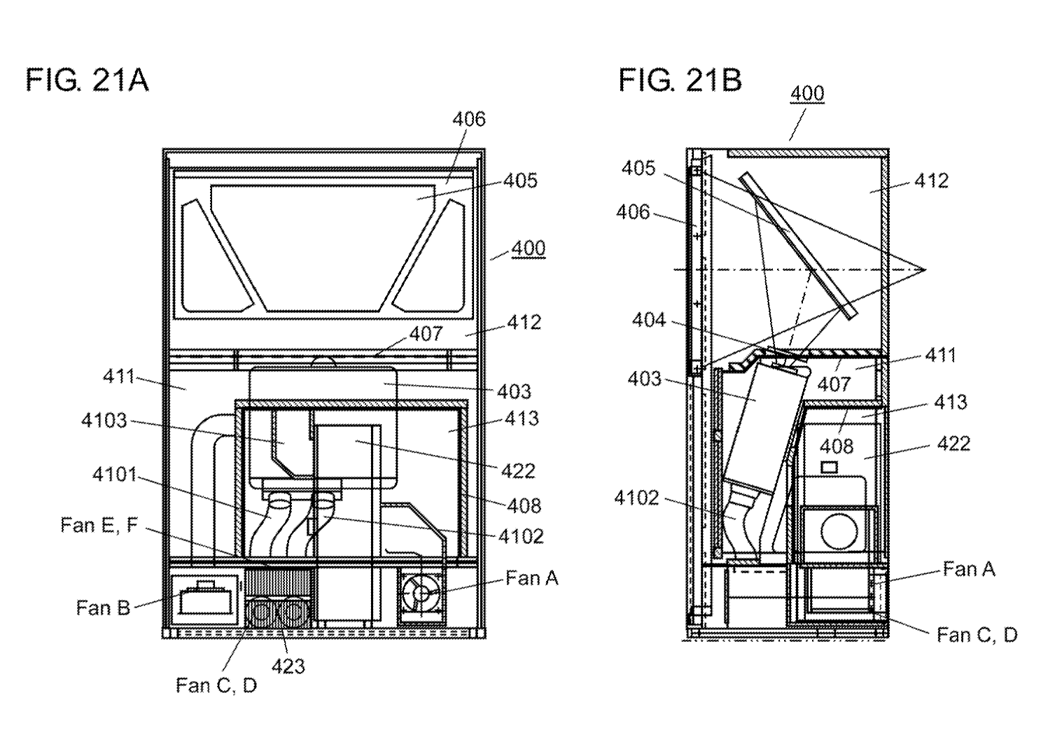

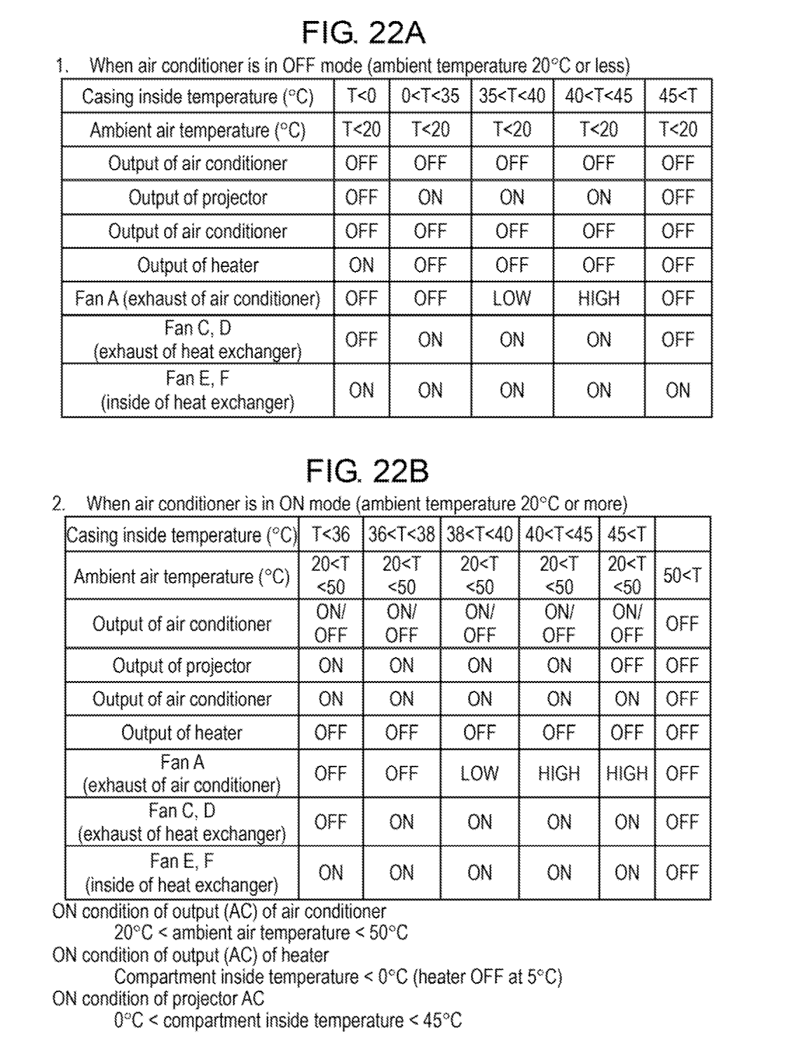

Next, a basic concept and functions about an image display device in accordance with the second exemplary embodiment of the present invention are explained by referring to FIG. 19 through FIG. 22. FIG. 19 is a layout diagram showing a principal configuration of image display device 400 in accordance with the second exemplary embodiment of the present invention (hereinafter referred to as “this device 400”). FIG. 20 is a principal layout diagram showing an application example about basic configuration of this device 400, FIG. 21A and FIG. 21B are respectively a front view and a side view showing a principal layout of an example of specific configuration of this device 400, and FIG. 22A and FIG. 22B are operation explanatory diagrams showing setting examples of control mode relating to temperature control of the inside when the air conditioner of this device 400 is in OFF mode and ON mode, respectively. In FIG. 22A and FIG. 22B, “LOW” means the fan rotating speed is low, and “HIGH” means the fan rotating speed is high.

This device 400 includes projection type projector unit 403 (hereinafter abbreviated as “projector 403”) disposed in the inside of casing 402 as an image display unit, window 404, mirror unit 405, and transmission type screen 406, and the image information issued from projector 403 is projected on screen 406 by way of window 404 and mirror 405, thereby exhibiting the function of displaying the image on a wide screen. In projector 403, a personal computer or other information processing device (not shown) is connected, and information necessary for information presentation service is accumulated, or the information can be acquired from outside by way of a communication circuit.

Principal elements and functions for configuring this device 400 are explained.

Casing 402 of this device 400 has outer armor case 402a and accommodating casing 402b, and the inside of accommodation casing 402b is divided into three accommodation parts 411, 412, 413 by means of wall surface members 407, 408.

First accommodation part 411 (hereinafter referred to as “accommodation part 411”) is formed like a box having window 404 assembled in first heat insulating member 414 (hereinafter referred to as “heat insulating member 414”) disposed in the inside as a heat insulating part, and has projector 403 and heater 421 having the surrounding covered with cover 403a as outer armor casing in the inside. Specifically, accommodation part 411 is disposed for cooling projector 403 as heat source, and has a function of preventing the cold air supplied from the cooling part (described below) from diffusing to the surrounding, and it is effective to enhancing the cooling efficiency of projector 403. The material of heat insulating member 414 is, for example, foamed urethane, and window 404 may be made of a laminated glass material. Heater 421 is disposed for the purpose of controlling the temperature of this device 400, when the temperature of a specified position (described below) of this device 400 become lower than the operation temperature, by operating heater 421 for raising the temperature to the operation temperature. In this configuration, this device 400 can be used in a low temperature environment. Therefore, the usable temperature range of this device 400 is extended. The temperature is detected by thermal sensor 432 disposed in the inside of accommodation part 411.

Second accommodation part 412 (hereinafter referred to as “accommodation part 412”) is formed by adhering second heat insulating member 415 (hereinafter referred to as “heat insulating member 415”) to both sides of the inside and to the back side as heat insulating part, and mirror 405 and screen 406 are disposed for magnifying and projecting the image information issued from projector 403. Accommodation part 412 is disposed for the purpose of preventing heating of mirror 405 or screen 406 when outer armor case 402a is exposed to solar heat or the like, and has a function of shutting off transmission of heat to the inside, and it is effective to suppress temperature rise of the member relating to magnification and projection of image information issued from projector 403. Heat insulating member 415 is made of foamed urethane or the like, and the inside surface is made of a black material of high rate of radiation, so as to absorb the visible light. As a result, in accommodation part 412, heat is released effectively, and the contrast of display image is enhanced, so that the image quality may be improved.

Third accommodation part 413 (hereinafter referred to as “accommodation part 413”) is disposed at the lowest position of accommodation casing 402b at the lower side of accommodation parts 411, 412, and has a function of a driving unit for this device 400. Accommodation part 413 includes air conditioner 422 as a first cooling device having a compressor, a condenser, and an evaporator, heat exchanger 423 as a second cooling device having heat exchange function by heat conduction, and others such as power source unit and control device (neither shown). Heat exchanger 423 may be realized by a plate fin, a heat pipe, a radiator, or the like. Hence, by combined use of air conditioner 422 and heat exchanger 423, projector 403 can be cooled efficiently, and stable heat exchange of high quality can be executed efficiently.

Next, as another feature of this device 400, the configuration and function about cooling of projector 403 as an image display unit are described by referring to FIG. 19.

This device 400 includes projector 403 as an image display unit capable of projecting the image forward in specified dimension and specified luminance at specified projection distance, and transmission type screen 406 for displaying the image projected by projector 403, which are contained in casing 2, and it is an image display device for projecting backward the image on screen 406 disposed on the projection route of projector 403. Casing 402 has outer armor case 402a, and accommodation casing 402b, and includes accommodation part 411 disposing projector 403, accommodation part 412 disposing screen 406, and accommodation part 413 disposing a cooling part for cooling the inside of casing 402, and accommodation parts 411, 412, 413 are divided by wall surface members 407, 408.

By isolating projector 403 completely from the accommodation location of the cooling part, an efficient cooling route is composed, and the cooling efficiency is enhanced, and at the same time, moreover, vibration, dust, and other structural adverse effects due to disposition of the cooling part, other devices, and other components can be suppressed. As a result, relating to the image display device for outdoor installation, in particular, the cooling function is enhanced, the loads about the cooing unit can be lessened, and the efficiency is enhanced, thereby realizing an image display device having high precision, high luminance, and temperature adjustment function of high quality that can be installed in various outdoor environments.

In this device 400, moreover, heat insulating members are disposed at least in accommodation parts 411, 412. Accordingly, the inside of this device 400 can be divided, and insulated thermally, so that projector 403 and screen 406 can be cooled individually. Therefore, depending on the cooling conditions about the mounted devices and components such as projector 403 and screen 406, the temperature can be controlled appropriately.

A structural feature about the cooling part of this device 400 is explained.

As shown in FIG. 19, circulation flow path A of air for cooling projector 403 is provided. In FIG. 19, the cooling route of the air exhausted from projector 403 is indicated by arrows.

Circulation flow path A is formed in flow paths of a closed loop consisting of flow paths a1 to a13 in which accommodation part 411, air conditioner 422 and heat exchanger 423 are connected by tubular members or draft ducts (“closed flow path” shown in FIG. 19). In the air circulation sequence, the air exhausted from exhaust port 403c of projector 403 by blower (fan) 403d is guided to the outside from accommodation part 411, and is cooled by heat exchanger 423, and is further cooled by air conditioner 422, and then sent into accommodation part 411, and a cooled air is supplied to projector 403 from intake port 403b of projector 403.

In the configuration of accommodation part 411 relating to circulation flow path A, accommodation part 411 has intake port 411a and exhaust port 411b as air flow paths, and intake port 411a and exhaust port 411b are connected without gap with flow paths (flow paths a3 to a9) disposed outside of accommodation part 411, and thereby circulation flow path A is composed. Further, blowers 423d, 422d may be disposed in flow path (tubular member) a5 from heat exchange 423 and flow path (tubular member) a8 from an conditioner 22. By disposing blowers 423d. 422d, decline of pressure loss of the convection of flow paths a1 to a13 circulating in the inside can be suppressed low, and the air volume can be assured.

In this configuration, cooling air can be supplied from intake port 411a, and the heated air discharged from projector 403 can be exhausted outside from exhaust port 411b. Therefore, projector 403 can be cooled efficiently and securely.

Air conditioner 422 and heat exchanger 423 are disposed in accommodation part 413 in the lowest part of casing 402, and are thermally isolated and clearly divided in airtight state by accommodation part 411 disposing projector 403, wall surface member 407, and wall surface member 408. Intake and exhaust relating to cooling in air conditioner 422 are executed through flow path B (flow paths b1 to b4), and outside air is fed in from intake port 422a, and is exhausted to the outside of casing 402 by operating blower (fan) 422c from exhaust port 422b. Blower 422c is disposed near exhaust port 422b. Similarly, blower 423c is disposed near exhaust port 423b of heat exchanger 423, and intake and exhaust relating to cooling in heat exchanger 423 are executed through flow path C (flow paths c1 to c3), and outside air is fed in from intake port 423a, and is exhausted to the outside of casing 402 by operating blower (fan) 423c from exhaust port 423b. Therefore, the two cooling devices are exhausted by accommodation part 413 disposed in the lowest part of casing 402, and effects of temperature rise due to direct sunlight in intake and exhaust can be suppressed.

In accommodation part 413, aside from air conditioner 422 and heat exchanger 423 (hereinafter referred to as “cooling devices 422, 423”), flow path D (flow paths d1 to d3) is provided, and outside air is fed in from intake port Da, and is exhausted to the outside by means of blower Dc through exhaust port Db. As a result, elevation of internal temperature of accommodation part 413 can be suppressed: Accommodation part 411 has blower (fan) 411c for agitating the inside air, and if water drops are formed in the inside, the function of promoting evaporation is provided.

As described above, by using air circulation flow path A, the exhaust discharged from projector 403 can be cooled in two stages by using two cooling devices 422, 423, and unstable ambient air is not used for cooling. Therefore, the cooling conditions are stabilized, and adverse effects on projector 403 such as foreign deposits due to invasion of foreign matter such as dust into cooling air can be suppressed. As a result, as for cooling of projector 403, cooling with high stability and high quality is realized.

In circulation flow path A, meanwhile, by using tubular member or draft duct, circulation flow path A may be composed air-tightly by using inexpensive members.

This device 400 is further provided with heating unit 421, and the inside temperature of this device 400 can be elevated, and this device 400 can be used in low temperature environment, and the usable temperature range can be extended.

Casing 402 of this device 400 is provided with casters (not shown) for moving on the floor, and hence this device is portable. Therefore, this device 400 can be easily changed in direction, or moved in position, and the convenience is enhanced in the installation and maintenance of this device 400.

The method of temperature control of this device 400 is explained.

This device 400 has thermal sensor 431 disposed near intake port 422a of air conditioner 422, and also thermal sensor 432 is disposed near intake port 403b disposed in outer armor cover 403a of projector 403. As a result, near intake port 422a of air conditioner 422, the ambient air temperature around this device 400 can be detected, and near intake port 403b of projector 403, the temperature of the air for cooling projector 403 can be detected. Therefore, the temperature of ambient air used for cooling, and the temperature of the air for cooling projector 403 can be accurately detected, and the air can be taken in, and the precision of temperature control about cooling can be enhanced.

As the method of temperature control about cooling of projector 403 disposed in accommodation part 411, the ambient air temperature detected by thermal sensor 431 and the inside temperature of accommodation part 411 detected by thermal sensor 432 are respectively divided into a plurality of temperature ranges, and a plurality of temperature control modes is set, relating to projector 403, air conditioner 422, heat exchanger 423, heater 421, and a plurality of blowers 422c, 423c, Dc, 411c, and the function is set for at least one of ON/OFF and output changeover in each temperature control mode, and the period of cycle casing inside temperature and temperature control are maintained in a specific range. By this method, a setting example of control mode about temperature control in the inside of casing 402 is shown in FIG. 22 (related drawing: FIG. 21).

In this configuration, a plurality of temperature control modes is set in consideration of the ambient air temperature and the inside temperature of accommodation part 411, and by each temperature control mode, relating to projector 403, air conditioner 422, heat exchanger 423, heater 421, and blowers 422c, 423c, Dc, 411c, and the function is set for at least one of ON/OFF and output changeover, and thereby the temperature control in the inside of casing 402, in particular in the inside of accommodation part 411 can be maintained in a specific range in the range of control temperature and the period of temperature control cycle.

Therefore, by setting appropriately the operation and function of the image display unit, the heating unit, and the blower in each control mode depending on the situation of the ambient air temperature and the inside temperature of casing 402, the period of the temperature control cycle relating to cooling of the image display unit can be set appropriately. Hence, relating to projector 3, air conditioner 422, heat exchanger 423, heater 421, and blowers 422c, 423c, Dc, 411c concerned with the temperature control, the changeover frequency of ON/OFF and function can be suppressed, and troubles hardly occur about the devices mounted in this device 400, so that the image display device of a long service life may be realized.

An application example about the configuration of this device is explained by referring to FIG. 20.

FIG. 20 is a principal layout diagram showing a basic configuration of application example about cooling of projector 403. The configuration is same as shown in FIG. 19. unless otherwise specified, and some of the reference numerals are omitted.

In the example shown in FIG. 20, as compared with FIG. 19, accommodation part 413 is divided by wall surface member 409 into two sections, that is, accommodation part 416 as fourth accommodation part, and accommodation part 417 as fifth accommodation part. In accommodation part 416 and accommodation part 417, flow path E and flow path F are formed by the intake port, the exhaust port, and the blowers in order to exchange the inside air with the outside of casing 402 by intake and exhaust. Further, accommodation part 416 is provided with heat absorbing part 4231 of heat exchanger 423 and heat absorbing part 4221 of air conditioner 422, and accommodation part 417 is provided with heat releasing part 4232 of heat exchanger 423 and heat releasing part 4222 of air conditioner 422. Herein, heat absorbing part 4221 of air conditioner 422 corresponds to the evaporator mentioned above, and the heat releasing part 4222 corresponds to the compressor and the condenser. In such configuration, the portions responsible for heat absorbing and heat releasing of cooling devices 422, 423 can be separated by wall surface member 409, so that, a more efficient cooling may be possible.

Besides, accommodation part 417 is provided with intake port 423a and exhaust port 423b of heat exchanger 423, and intake port 422a and exhaust port 422b relating to cooling of air conditioner 422. In such configuration, the intake port and the exhaust port relating to cooling devices 422, 423 can be concentrated and disposed in accommodation part 417 positioned in the lowest part of the casing. Therefore, the cooling devices can take in and exhaust the air at a position remote from projector 403 in accommodation part 417 positioned in the lowest part of casing 402, and the outside temperature environment of casing 402 is prevented from influencing projector 403 by way of the intake and exhaust ports of the cooling devices. In addition, since the lowest part of casing 402 is hardly exposed to direct sunlight, and effects of temperature rise of the outside of casing 402 on the intake and exhaust of the cooling devices can be suppressed to minimum limits. As a result, the temperature rise of projector 403 can be suppressed, and the cooling efficiency of the cooling devices can be enhanced, and the load can be lessened.

Division of accommodation part 416 and accommodation part 417 can be simplified in terms of air-tightness and shielding of heat, by changing the structure of the division members depending on the design conditions. Hence, when accommodation part 413 and accommodation part 416 are combined and used, or when disposing devices and members over the two accommodation parts, the degree of freedom of use is enhanced, and the casing of the image display device of high degree of freedom in design and excellent in practicability may be realized.

In this example, exhaust port 403c of projector 403 and intake port (inlet port, not shown) of heat exchanger 423 are connected by way of tubular members a1, a2, a3, and the exhaust from projector 403 is sent into heat exchanger 423 by way of an exclusive flow path. Similarly, intake port 403b of projector 403 and output port (not shown) of air conditioner 422 are connected by way of tubular members a8 to a13 by way of an exclusive flow path. In this configuration, intake and exhaust of projector 403 can be executed by the tubular members by way of the exclusive flow path, and the cooling efficiency can be enhanced. Herein, it is preferable that tubular members a1, a2, a10 through a13 for passing through the insulated accommodation part 411 be insulated thermally. Moreover, of the tubular members passing through accommodation part 416, tubular members a3, a5, and a6 are preferred to be released of heat in order to lower the temperature of the exhaust from projector 403, and to the contrary tubular members a8 and a9 are preferred to be insulated in order to keep the temperature of the air cooled by air conditioner 422. Furthermore, in this application example, too, blowers may be disposed in flow path (tubular member) a5 from heat exchanger 423 and flow path (tubular member) a8 from air conditioner 422. In FIG. 20, meanwhile, tubular members are used for connecting between exhaust port 403c of projector 403 and the intake port of heat exchanger 423, and between intake port 403b of projector 403 and the output port of air conditioner 422, but only one of the paths may be connected by tubular members.

Moreover, blower 411c is disposed in accommodation part 411, and the inside air can be agitated. Therefore, if water drops are formed due to surrounding weather conditions or cooling or other thermal environment in the image display device, vaporization of water drops is promoted by the blower, and the heat of vaporization may be utilized again, in cooling, and water drops have no effect on the function of this device 400, and a stable cooling quality can be maintained.

As shown in this application example, projector 403 has outer armor cover 403a in which intake port 403b and exhaust port 403c are disposed as air flow paths, and at least one of intake port 403b and exhaust port 403c is connected to at least one of intake port 411a and exhaust port 411b of accommodation part 411 by way of flow path (at least one of flow path a3 and flow path a9). In such configuration, the air heated by projector 403 is not diffused inside of the accommodation part, and can be exhaust to the outside of accommodation part 416 or accommodation part 417 by way of an exclusive tubular flow path from the exhaust port. Therefore, the exhaust of projector 403 is efficient and secure. In addition, in this device 400, by cooling by making use of the intake port and the exhaust port disposed in outer armor case 402a, the cooling is more efficient and secure.

In the meantime, casing 402 is not in a closed structure, but invasion of dust can be prevented by installing a filter (not shown) at the intake or exhaust.

An example of a specific configuration of an application of the preferred embodiment of the present invention in an image display device is shown in FIG. 21.

In FIG. 21, this device 400 has its three accommodation parts 411, 412, 413 divided by wall surface members 407, 408, and projector 403 is disposed in accommodation part 411, and mirror 405 and screen 406 are disposed in accommodation part 412, and cooling devices 422, 423 are disposed in accommodation part 413. Also in accommodation part 413 in the lowest part of the casing, intake and exhaust parts of cooling devices 422, 423 are disposed, and the inside air is agitated by fans A to F, or exhausted to the outside.

Further, flow paths 4101, 4102, 4103 closed by tubular members or draft ducts, and other flow paths are disposed, and a circulation flow path for cooling projector 403 is formed.

As described above, by using the image display device of the present invention, in the projection type image display device using the projector, appropriate cooling is possible depending on various cooling conditions relating to the mounted devices and parts such as the projector and the screen, and the image display deice of high precision and high luminance that can be installed in various outdoor environments can be realized. In particular, being excellent in weather resistance and capable of operating in severe ambient air temperature conditions, a very useful image display device suited to information presentation service such as outdoor advertising can be realized.

As an application example about the use of this device 400, the accommodation part 411 and the accommodation part 412 in FIG. 19 are separated, and are contained in the casing having a window together with accommodation part 413, so that an image display device of front projection type can be realized.

### INDUSTRIAL APPLICABILITY

According to the image display device of the present invention, the image display device high in luminance and excellent in weather resistance can be presented. It is therefore useful as the image display device to be used outdoors.

### DESCRIPTION OF REFERENCE MARKS

1, 100, 200, 300, 400 Image display device

### 2, 102, 201, 301, 402, 902, 1002 Casing

2a Door unit
2b, 176 Ventilation port

### 2c Caster

402a Outer armor case
402b Accommodation casing
3, 103, 403 Projector (image display unit)
3a, 103a, 403a Cover (outer armor casing)

### 4, 202, 302, 404 Window

### 5, 405 Mirror

### 6, 406 Screen

61 Fresnel lens
62 Diffusion plate
63 Front protective panel
64 Air passing layer
65 Antistatic film

### 66 Cross fan

7 Accommodation part
8, 108 Drive unit
11, 111, 311 First heat insulating part
11a, 414 First heat insulating member
12 Second heat insulating part
12a, 415 Second heat insulating member
13, 14 Dew condensation sensor

### 21 Heater

22 Heat exchanger

### 23, 123 Compressor

### 24, 124 Condenser

### 25, 125 Evaporator

### 26 Fan

31, 32, 171, 172 Circulation route (cooling route)
151, 173, 951, 1051 Intake port
152, 174 Exhaust port

### 153 Evaporation pan

161, 162 Solar panel

### 163 Battery

164 Position information transmitter (GPS transmitter)
175 Exhaust route
407, 408, 409 Wall surface member (division member)
411 First accommodation part
412 Second accommodation part
413 Third accommodation part
416 Fourth accommodation part
417 Fifth accommodation part

### 421 Heater

422 First cooling part (air conditioner)
423 Second cooling part (heat exchanger)
403b, 411a, 422a, 423a, Da Intake port
403c, 411b, 422b, 423, Db Exhaust port

### 403d, 411c, 422c, 423c, Dc Blower

431, 432 Thermal sensor
4101, 4102 4103, A, B, C, D, a1 to a13, b1 to b4, c1 to c3, d1 to d3 Flow path
4221, 4231 Heat absorbing part
4222, 4232 Heat releasing part

### 881, 882, 883, 981, 1081 Filter

### 982, 1082 Cleaner

### 1083, 1084 Shutter

1201, 1204 Relay switch
1202 Projector drive circuit unit
1203 Heater drive circuit unit
1205 Compressor drive circuit unit
1301 Suspension structural body
1301a, 1301b, 1301c, 1301d Suspension angle
1302a Vibration absorbing member (buffer member)
1303, 1304 Thermal sensor

1-33. (canceled)

34. An image display device comprising:
an image display unit capable of projecting forward an image in a specified dimension and at a specified luminance at a specified projection distance; and
a transmission type screen for displaying the image projected by the image display unit,
a casing for containing the image display unit and the transmission type screen and projecting backward the image to the screen disposed on a projection route of the image display unit,
wherein the casing includes a heat insulating part, and a cooling part for cooling the inside of the casing, and the heat insulating part has a first heat insulating part disposed in a peripheral part of the image display unit for insulating from heat, and a second heat insulating part disposed in a peripheral part of the screen for insulating from heat, and the location for disposing the first heat insulating part and the second heat insulating part is divided by wall surface members.

35. The image display device of claim 34, wherein the casing has an intake port and an exhaust port, and the intake port is provided with a dust filter.

36. The image display device of claim 34, wherein the casing has an intake port and an exhaust port, and the intake port and the exhaust port are closed in cooperation with on/off switching of the power source of the image display device.

37. The image display device of claim 34, wherein the casing is provided with a thermal sensor and a heating part disposed in its inside, and the heating part is operated when the temperature detected by the thermal sensor is lower than a specified temperature, and the power source of the image display unit is turned on when becoming higher than the specified temperature.

38. The image display device of claim 34, wherein the image display unit is further provided with a cover, and the inside of the cover has a second thermal sensor, and the number of lit lamps of the light source of the image display unit is controlled when the temperature detected by the second thermal sensor is more than a specified temperature.

39. The image display device of claim 34, wherein the cooling part has a first cooling part provided with a compressor, a condenser, and an evaporator, and a second cooling part provided with a heat exchanger by heat conduction.

40. The image display device of claim 39, further comprising means for detecting the operation rate of the compressor, and the image display device is driven and controlled depending on the operation rate of the compressor.

41. The image display device of claim 34, wherein the casing is provided with a dew condensation sensor and a heating part disposed in its inside, and the heating part is operated when dew condensation is detected by the dew condensation sensor, and the power source of the image display unit is turned on when dew condensation is not detected.

42. The image display device of claim 39, further comprising a third cooling part in the second heat insulating part.

43. The image display device of claim 42, wherein the third cooling part cools the transmission type screen.

44. The image display device of claim 34, wherein the casing is provided with a first accommodation part containing the image display unit, a second accommodation part containing the screen, and a third accommodation part containing the cooling part for cooling the inside of the casing, and the first accommodation part, the second accommodation part, and the third accommodation part are divided by wall surface members.

45. The image display device of claim 44, wherein the third accommodation part is further divided into a fourth accommodation part and a fifth accommodation part, and a heat absorbing part relating to the cooling part is disposed in the fourth accommodation part, and a heat releasing part relating to the cooling part is disposed in the fifth accommodation part.

46. The image display device of claim 45, wherein the fifth accommodation part is disposed in the lowest part of the casing, and an intake port and an exhaust port relating to the cooling part are disposed in the fifth accommodation part.

47. The image display device of claim 44, wherein the cooling part is provided with an air circulation flow path for cooling the image display unit.

48. The image display device of claim 47, wherein the first accommodation part has an intake port and an exhaust port as air flow paths, and the intake port and the exhaust port are connected individually to a flow path disposed in the outside of the first accommodation part, thereby composing the circulation flow path.

49. The image display device of claim 47, wherein the image display unit is provided with an outer armor casing having an intake port and an exhaust port as air flow paths, and at least one of the intake port and the exhaust port of the outer armor casing is connected by a member forming a flow path with at least one of the intake port and the exhaust port of the first accommodation part.

50. The image display device of claim 46, wherein the cooling part has a first cooing device provided with a compressor, a condenser, and an evaporator, and a second cooling device provided with a heat exchanger by heat conduction.

51. The image display device of claim 50, wherein a circulation flow path is a flow path for cooling the air exhausted from the image display unit by the second cooling device, and then cooling by the first cooling device.

52. The image display device of claim 44, wherein the temperature of the casing outside and the temperature of the casing inside detected by the thermal sensor are individually divided into a plurality of temperature ranges and a plurality of temperature ranges is set, and the function is set about at least on/off and output changeover in each temperature control mode, relating to the image display unit, the cooling part, the heating part, and the blower, and the period of temperature and temperature control cycle in the casing is maintained within a specific range.
